(19) United States
(12) Patent Application Publication
(10) Pub. No.: US 2015/0135024 A1
(43) Pub. Date: May 14, 2015

(54) METHODS AND APPARATUS FOR DETECTING FRAME NUMBER DISCONTINUITIES BETWEEN RADIO NODES

(71) Applicant: Telefonaktiebolaget L M Ericsson (publ), Stockholm (SE)

(72) Inventors: Alessandro Caverni, Stockholm (SE); Anders Jonsson, Taby (SE); Nianshan Shi, Jarfalla (SE); Jose Luis Pradas, Stockholm (SE)

(73) Assignee: Telefonaktiebolaget L M Ericsson (publ), Stockholm (SE)

(21) Appl. No.: 14/400,386

(22) PCT Filed: Apr. 30, 2013
(86) PCT No.: PCT/SE2013/050480

§ 371 Date: Nov. 11, 2014

Related U.S. Application Data
(60) Provisional application No. 61/645,762, filed on May 11, 2012.
(60) Provisional application No. 61/754,099, filed on Jan. 18, 2013.

(51) Int. Cl. G06F 11/07; H04L 1/00; H04L 7/00; H04L 1/18

(52) U.S. Cl. CPC G06F 11/0793; H04L 1/1812; H04L 1/0041; G06F 11/076; H04L 7/0016
USPC 714/704

(57) ABSTRACT

A transmitting node communicates with a receiving node using a multi-layer communications protocol having a lower media access control, MAC, layer and a higher radio link control, RLC, layer. An RLC controller operates in an RLC unacknowledged mode, RLC UM. A MAC controller operates using hybrid automatic repeat request, HARQ, for transmitted MAC protocol data units. The RLC controller in the RLC UM transmits RLC protocol data units via the MAC layer. The MAC controller monitors transmission errors at the MAC layer and informs the RLC controller when detecting a predetermined number of consecutive transmission errors or a predetermined number of transmission errors during a predetermined time period so that the RLC controller can perform one or more actions.

### TECHNICAL FIELD

The technology relates to radio communications, and in particular, to detecting, correcting, and if possible preventing ciphering errors between two radio nodes.

### BACKGROUND

The technology in this application is described in an example UTRAN/Wideband Code Division Multiple Access (WCDMA) context. In particular, the technology is related to the WCDMA Radio Link Control (RLC) protocol, Unacknowledged Mode (UM) transmission and reception, ciphering, Medium Access Control (MAC) Hybrid ARQ (HARD) process, the air interface (Uu) and the interface between NodeB and Radio Network Controller (RNC) (Iub/Iur interface) in a UTRAN type of system such as the example illustrated in FIG. 1. The RNC communicates with one or more core network nodes which are connected to one or more other networks, e.g., the Internet, public and private telephone networks, etc.

FIG. 2 is a diagram illustrating the lower levels of a protocol stack used in UTRAN including a physical (PHY) lowest layer L1, several L2 layers such as MAC, RLC, Packet Data Convergence Protocol (PDCP), and layer L3 including Radio Resource Control (RRC). This radio interface protocol architecture marks service access points with circles.

FIG. 3 shows a Protocol Architecture of HS-DSCH, Configuration without MAC-c/sh for the downlink.

FIG. 4 shows a Protocol Architecture of Protocol Architecture of E-DCH (MAC-i/is) for CELL_DCH for the uplink.

Whenever the RLC layer is configured in unacknowledged mode (UM), ciphering is performed by RLC itself. See 3GPP TS25.322v10.1.0 “Radio Link Control (RLC) protocol specification,” incorporated herein by reference.

For RLC UM mode, a ciphering unit is the Unacknowledged Mode Protocol Data Unit (UMD PDU) excluding the first octet, i.e., excluding the UMD PDU header. See FIG. 5.

The Sequence Number (SN), which is contained in the first octet of the UMD PDU, is not encrypted, whereas all the remaining octets (i.e., the Ciphering Unit) are encrypted when ciphering is activated. 3GPP TS33.102v10.0.0 “3G security; Security architecture,” incorporated herein by reference, defines parameters required by the RLC layer for ciphering. One of these parameters is the ciphering sequence number COUNT-C, which is 32 bits long. There is one COUNT-C value per up-link radio bearer and one COUNT-C value per down-link radio bearer using RLC Acknowledged Mode (AM) or RLC UM.

COUNT-C includes two parts: a short sequence number and a long sequence number. The short sequence number forms the least significant bits of COUNT-C while the long sequence number forms the most significant bits of COUNT-C. The update of COUNT-C depends on the transmission mode as described below. FIG. 6 shows the structure of COUNT-C for all transmission modes.

For RLC UM mode, the short sequence number is the 7-bit RLC sequence number (RLC SN) and this is part of the RLC UM PDU header. The long sequence number is the 25-bit RLC UM Hyper Frame Number (HFN), which is incremented at each RLC SN cycle. Since the Sequence Number (SN) has a length of 7 bits, its range is 128 PDUs. If the transmission/reception starts from sequence number (SN) 0, then the HFN is incremented after the transmission/reception of 128 PDUs. But the transmitting UM RLC entity does not receive any feedback information regarding the correct or erroneous reception of UM PDUs by the receiver side.

Since the transmitting UM RLC entity is not aware of whether the UM RLC PDUs are actually received or not by the receiving RLC entity, it will continue transmitting UM RLC PDUs whenever there is data received from higher layers and resources from lower layers are available. In case more than 127 consecutive UM RLC PDUs are transmitted but not received, or not correctly received, this will cause a mismatch between the current HFN value calculated at the transmitting and receiving side. If further UM PDUs are transmitted and received correctly, the COUNT-C on the transmitting and receiving side will be misaligned since a wrap around of the RLC Sequence Number has occurred on the transmitting side which the receiving side is unaware of, leading to a ciphering problem. The result is that the data in the RLC UM PDU will be erroneously deciphered since the RLC entities involved in the transmission/reception will not be able to detect the error and will just forward the corrupted PDUs to higher layers.

For example, assume HFN=0 and SN=1 for the last successful PDU transmission/reception and that the following 128 PDUs are transmitted, but not received correctly. The transmitting side increments the HFN by one because a complete SN cycle has occurred. For the next transmission, the SN=2, but the HFN on the transmitting side is 1 and not 0. If the receiving side receives this PDU correctly, it reads SN=2 and assumes that the HFN is still equal to 0, since its HFN has not been incremented. As a result, the COUNT-C's at sender and at the receiver do not match, causing a ciphering error. The same result occurs if more than 128 PDUs are not received correctly.

This error may for instance occur, for the downlink, as follows. First, assuming the initial RF condition is satisfactory, the UM RLC PDUs are correctly transmitted over HS-DSCH ([3GPP TS25.321v11.0.0 “Medium Access Control (MAC) protocol specification,” incorporated by reference) by the network and received by the UE. Then, the RF quality deteriorates, but not so much as to cause de-synchronization at L1 or a Radio Link Failure (3GPP TS25.214v11.1.0 “Physical layer procedures (FDD),” incorporated by reference) procedure. Nevertheless, the UE can not successfully decode packets on the High Speed Physical Downlink Shared Channel (HS-PDSCH). This may happen if the quality of the downlink Dedicated Physical Control Channel (DPCCH)/Fractional—Dedicated Physical Channel (F-DPCH) is sufficient to keep the UE in-sync, but the quality of the Shared Control Channel for the High Speed Downlink Shared Channel (HS-DSCH) (HS-SCCH) and the HS-PDSCH is not sufficient to allow a correct data reception. It is notable that the physical channels DPCCH and F-DPCH are power-controlled, whereas in contrast, the power of the HS-SCCH and HS-PDSCH is not based on feedback from the UE. The condition is compounded if this condition persists for a period of time corresponding to the transmission of 128 UM RLC PDUs.

In the current 3GPP standard, the NodeB is aware, by way of the MAC Hybrid ARQ, of unsuccessful transmissions of MAC-hs/ehs PDUs, because these MAC PDUs (and their re-transmissions) are either (1) not acknowledged or (2) negatively acknowledged by the UE. But because the MAC Hybrid ARQ processing is performed by the NodeB and the RLC protocol is handled by the RNC, the RNC is not aware of HARQ failures. This is illustrated in the FIGS. 7 and 8, where the MAC-hs/ehs entity, responsible for the DL HARQ functionality, resides in the NodeB (base station). Similarly, for the UL case shown in FIGS. 9 and 10, if the data is transmitted over E-DCH, the MAC-e/es and MAC-i/is entities in the UE are aware of the HARQ process failure.

But again, there is no mechanism that informs higher protocol layers (and in turn the network) of consecutive HARQ failures. This can be seen in FIG. 11 which shows a model of two unacknowledged mode peer entities configured for use without duplicate avoidance and reordering. Regarding the MAC-RLC interface and how a MAC failure is handled, there's no primitive from MAC to RLC to indicate a MAC HARQ failure occurrence.

It would also be desirable that any technology capable of detecting the loss of consecutive RLC PDUs be configurable depending on the transfer mode of the RLC PDUs (i.e. UM, AM or TM) and the logical channel associated to the PDUs. Different transfer modes and different logical channel may need different and independent mechanisms to detect the PDU loss.

### SUMMARY

A transmitting node communicates with a receiving node using a multi-layer communications protocol having a lower media access control, MAC, layer and a higher radio link control, RLC, layer. An RLC controller operates in an RLC unacknowledged mode, RLC UM. A MAC controller operates using hybrid automatic repeat request, HARQ, for transmitted MAC protocol data units. The RLC controller in the RLC UM transmits RLC protocol data units via the MAC layer. The MAC controller monitors transmission errors at the MAC layer and informs the RLC controller when detecting a predetermined number of consecutive transmission errors or a predetermined number of transmission errors during a predetermined time period so that the RLC controller can perform one or more actions.

Typically, in the RLC UM, the RLC controller does not receive any feedback information regarding correct or erroneous reception of the transmitted RLC protocol data units by the receiving node. In example embodiments, the transmission errors are MAC protocol data unit, MAC PDU, transmission failures which occur when a maximum number of HARQ transmissions for a MAC PDU is reached without receiving a positive acknowledgement for that MAC PDU. In one example embodiment, the MAC controller uses a counter to account for each MAC PDU transmission failure, and the counter is reset if the transmission of a MAC PDU is successful. In another example embodiment, the MAC controller uses a counter to account for each MAC PDU transmission failure occurring during the predetermined time period.

The technology described above may be implemented for each of multiple data flows, each of multiple logical channels, or each of multiple priority queues.

In one example embodiment, the transmitting node is a user equipment, UE, that includes the RLC controller and the MAC controller, and the one or more actions includes taking action to permit synchronization of the UE and radio base station.

In another example embodiment, a radio network controller, RNC, includes the RLC controller, and a radio base station communicating with the RNC and a user equipment, UE, includes the MAC controller. The MAC controller in the radio base station sends an error message to the RLC controller in the RNC so that the RNC controller can perform the one or more actions.

A further example embodiment includes the RNC transmitting to the radio base station a message indicating one or more data flows and/or one or more logical radio channels to be monitored for errors. The radio base station, in response, configures one or more de-synchronization detecting counter(s) and/or timer(s) for each of the one or more specific data flows, one or more specific logical channels, or one or more multiple priority queues indicated in the message. The configured one or more de-synchronization detecting counter(s) and/or timer(s) detect an error, and the radio base station sends a de-synchronization message to the RNC indicating de-synchronization between the UE and the radio base station.

In one example application, the RLC controller performs ciphering of data units to be transmitted.

In another example application, the RLC controller and the MAC controller are configured to support voice over IP, VoIP, communications, and the one or more actions includes an indication that a lack of synchronization is affecting the transmitting and receiving nodes. In some embodiments an elapsed time is determined between two consecutively-received RLC protocol data units. A timing offset is determined using the elapsed time, and the timing offset is used to acquire synchronization. The elapsed time is divided by a VoIP transmission rate so that the timing offset is determined using the elapsed time divided by the VoIP transmission rate.

Other example embodiments are directed specifically to an RNC communicating with a UE via a radio base station over a radio interface using a multi-layer communications protocol having a MAC layer and an RLC layer, where an RLC controller in the RNC operates in RLC UM, and where a MAC controller in the base station operates using HARQ for transmitted MAC data units. The RNC determines one or more parameters associated with the communication between the UE and the RNC for the base station to monitor. The RNC configures the radio base station to detect when a predetermined number of consecutive transmission errors or a predetermined number of transmission errors during a predetermined time period occurs. The RNC receives from the radio base station a message indicating the occurrence of a predetermined number of consecutive transmission errors or a predetermined number of transmission errors during a predetermined time period and sends a correction message to the radio base station based on the received message.

An example correction message includes information to permit synchronization between the UE and the radio base station, and the information may include a time offset to a transmission frame number.

In an example application, the RNC configures the radio base station by sending a message to the radio base station to monitor each of multiple data flows, each of multiple logical channels, or each of multiple priority queues for the predetermined number of consecutive transmission errors or the predetermined number of transmission errors during a predetermined time period.

Various example embodiments are described for configuring or signaling the predetermined value and for sending an error detection indication. In one example implementation in a UTRAN-based system, (1) example uplink and downlink signaling between RNC and NodeB and (2) example message formats for sending the error detection configuration, e.g., for each data flow or logical channel, and for sending an error detection, e.g., for each data flow or logical channel, are described.

### BRIEF DESCRIPTION OF THE FIGURES

FIG. 1 illustrates an example UTRAN type of system.

FIG. 2 is a diagram illustrating the lower levels of a protocol stack used in UTRAN.

FIG. 3 shows a Protocol Architecture of HS-DSCH, Configuration without MAC-c/sh for the downlink.

FIG. 4 shows a Protocol Architecture of Protocol Architecture of E-DCH (MAC-i/is) for CELL_DCH for the uplink.

FIG. 5 illustrates, for RLC UM mode, a ciphering unit.

FIG. 6 shows the structure of a ciphering sequence number COUNT-C.

FIGS. 7 and 8 are diagrams illustrating the MAC-hs/ehs entity, responsible for the DL HARQ functionality, residing in the NodeB (base station).

FIGS. 9 and 10 are diagrams illustrating the UL case where if the data is transmitted over E-DCH, the MAC-e/es and MAC-i/is entities in the UE are aware of the HARQ process failure.

FIG. 11 shows a model of two unacknowledged mode peer entities configured for use without duplicate avoidance and reordering.

FIG. 12 illustrates that a UE radio bearer may include multiple data flow and/or logical channels that may need to be treated differently.

FIGS. 13 and 14 show multiple MAC-d and MAC-c flows and priority queues for MAC-ehs and MAC-hs.

FIG. 15 shows an example MAC-ehs PDU with logical channel identifier (LCH-ID), Length (L), Transmission Sequence Number (TSN), Segmentation Indicator (SI), and Flag (F) fields.

FIG. 16 is a flowchart diagram illustrating example procedures for carrying out a first non-limiting example embodiment.

FIG. 17 is a flowchart diagram illustrating example procedures for carrying out a second non-limiting example embodiment.

FIG. 18 is a flowchart that illustrates an example for an incrementing counter implementation.

FIG. 19 is a flowchart that illustrates example procedures for a counter-timer implementation.

FIG. 20 is a flowchart that illustrates example procedures for a two counter-one timer implementation.

FIG. 21 is a flowchart that illustrates example procedures for a timer implementation.

FIGS. 22-25 are flowcharts illustrating example procedures for configuring the NodeB and UE to perform error detection and correction.

FIG. 26 is a graph showing, after HFN de-sync detection, an elapsed time between two consecutively received RLC PDUs.

FIG. 27 is a flowchart showing example procedures for synchronizing the UE and NodeB in a Voice over IP (VoIP) example context.

FIG. 28 shows non-limiting example function block diagrams of a UE, NodeB, and RNC that may be used to implement the technology described above.

FIG. 29 shows a signaling diagram illustrating non-limiting example messaging between a controlling RNC (CRNC) and the Node B over NBAP.

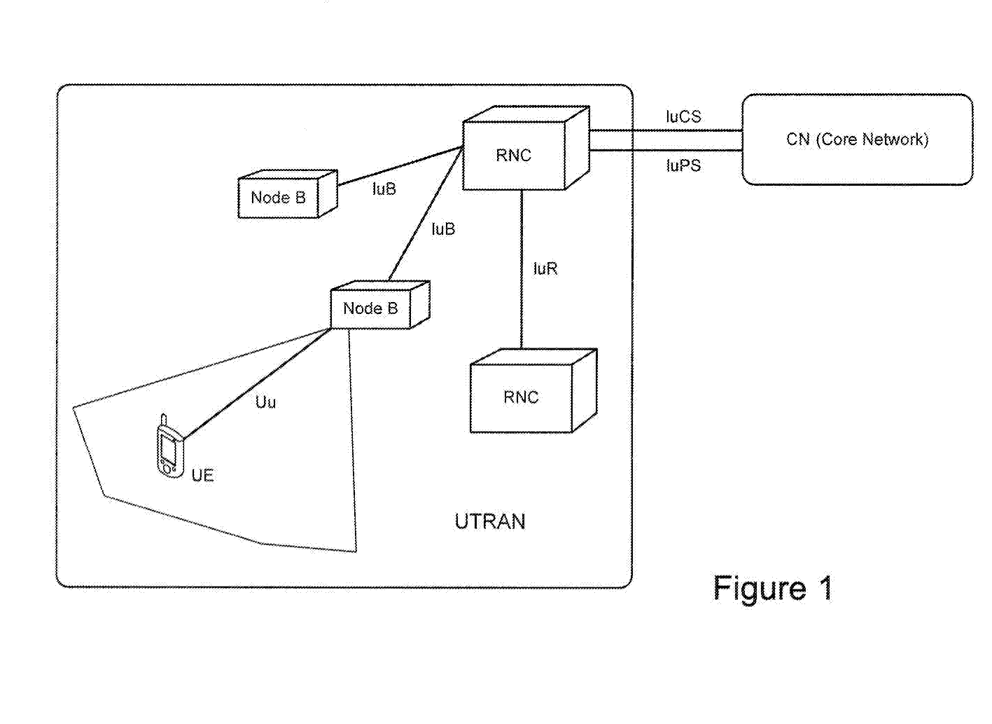

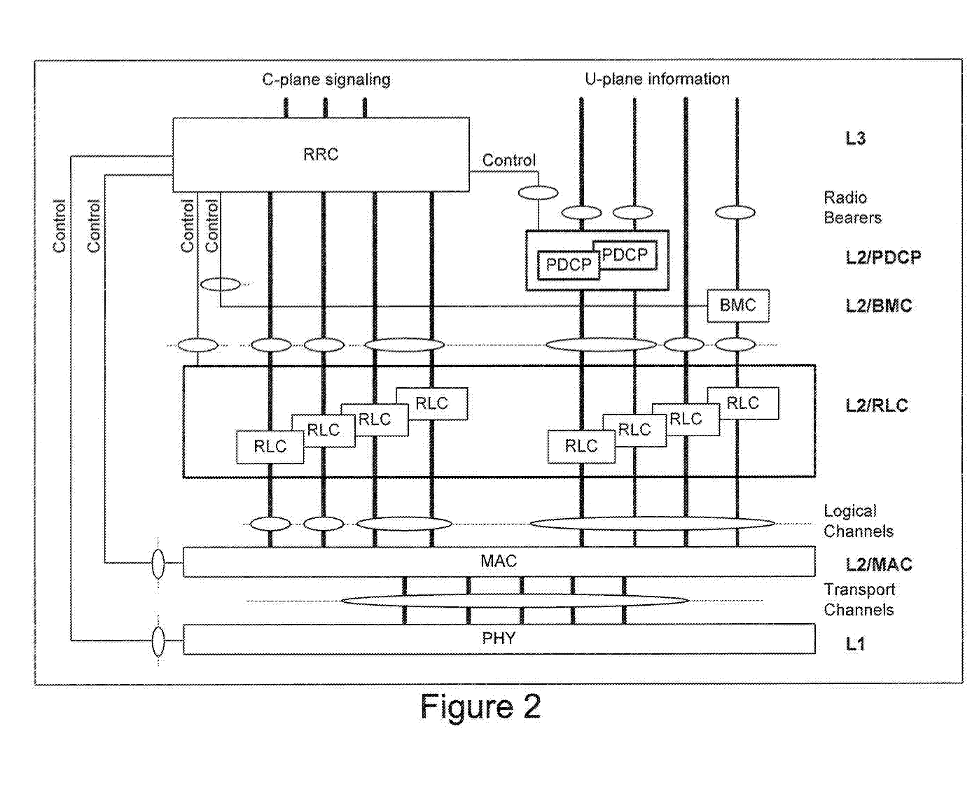

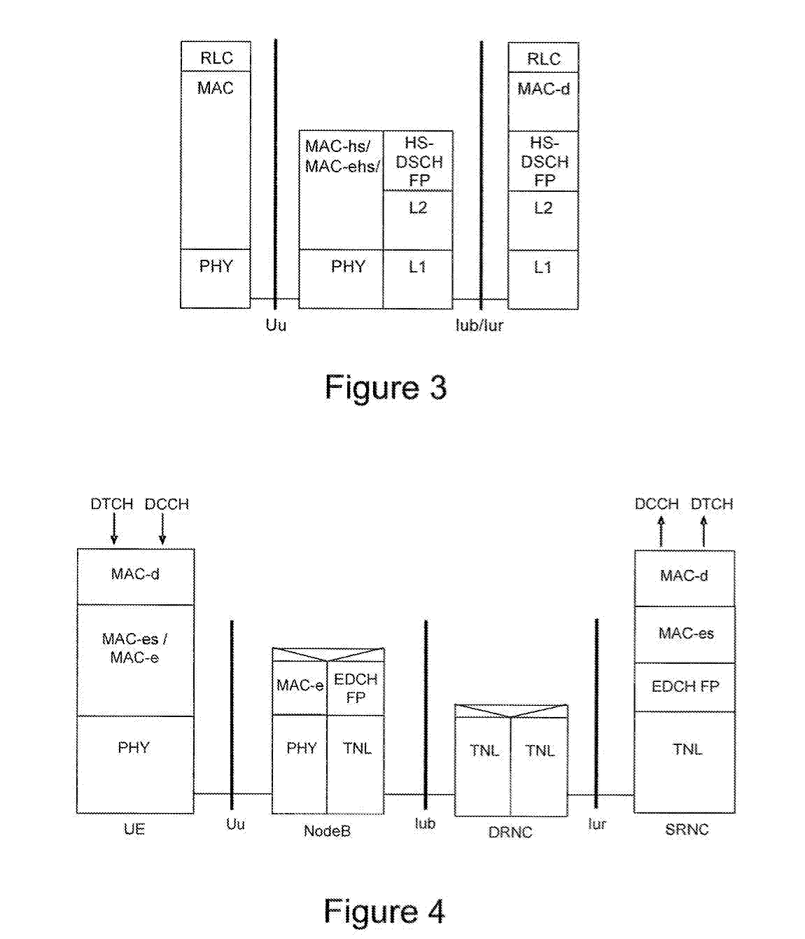

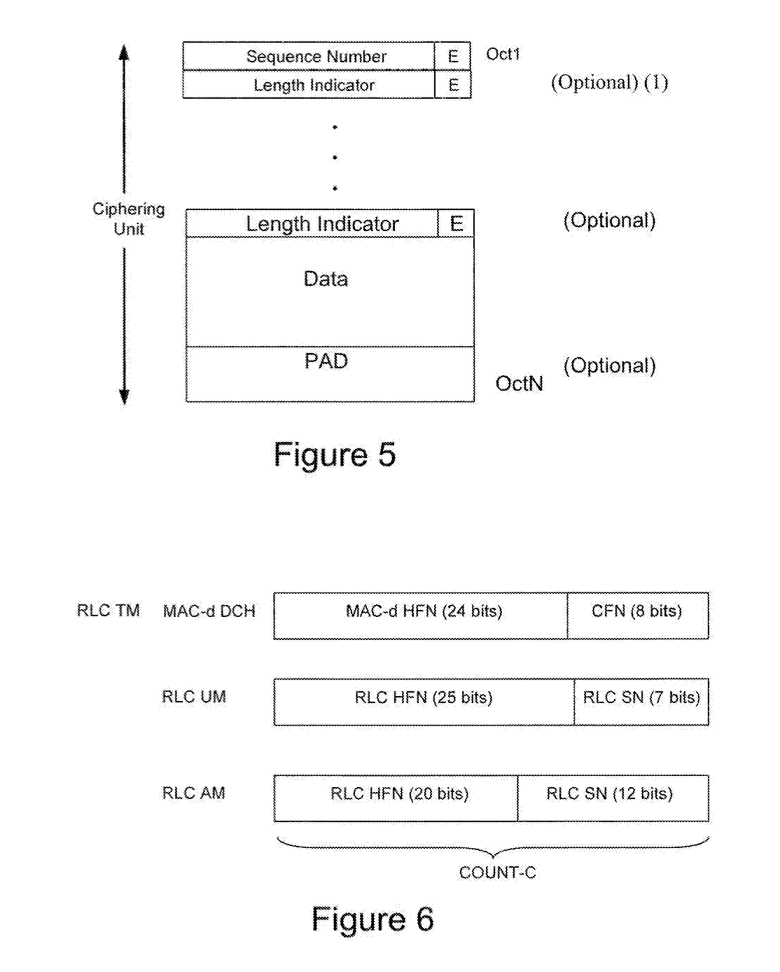

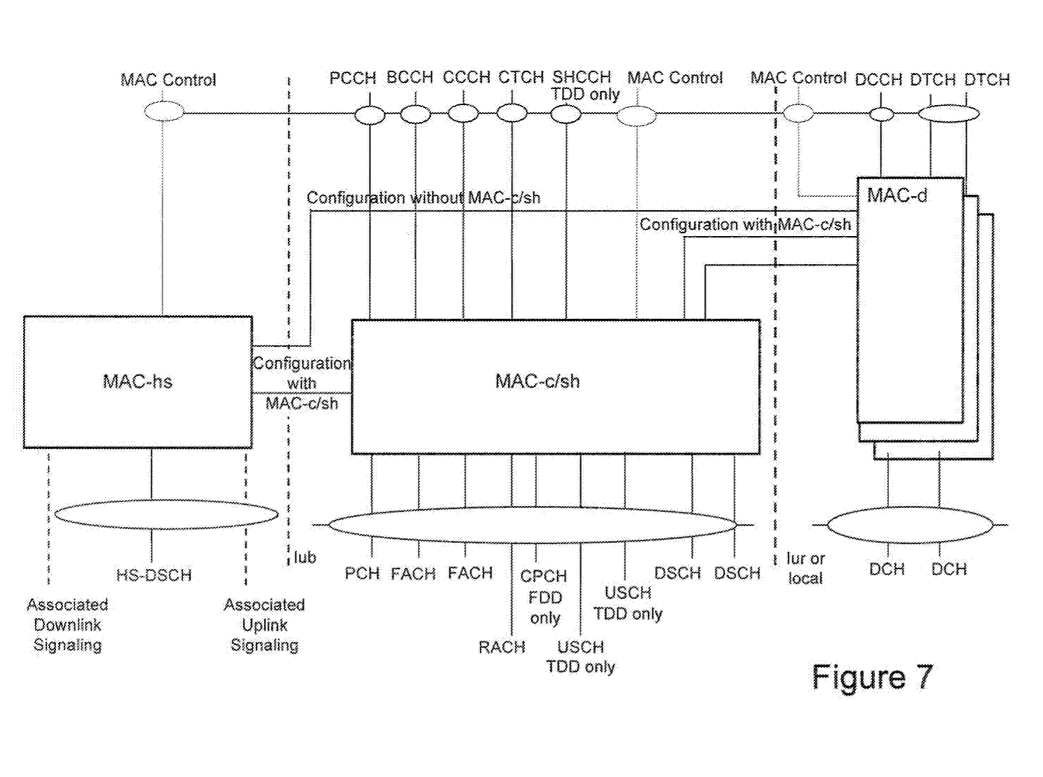

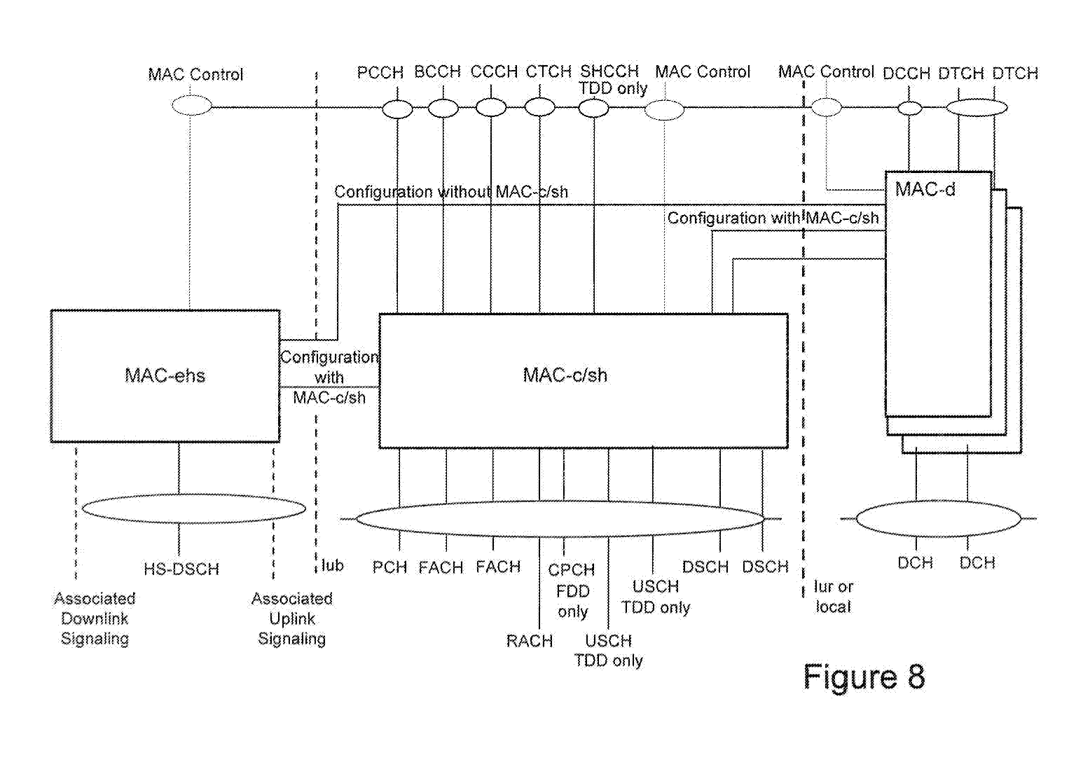

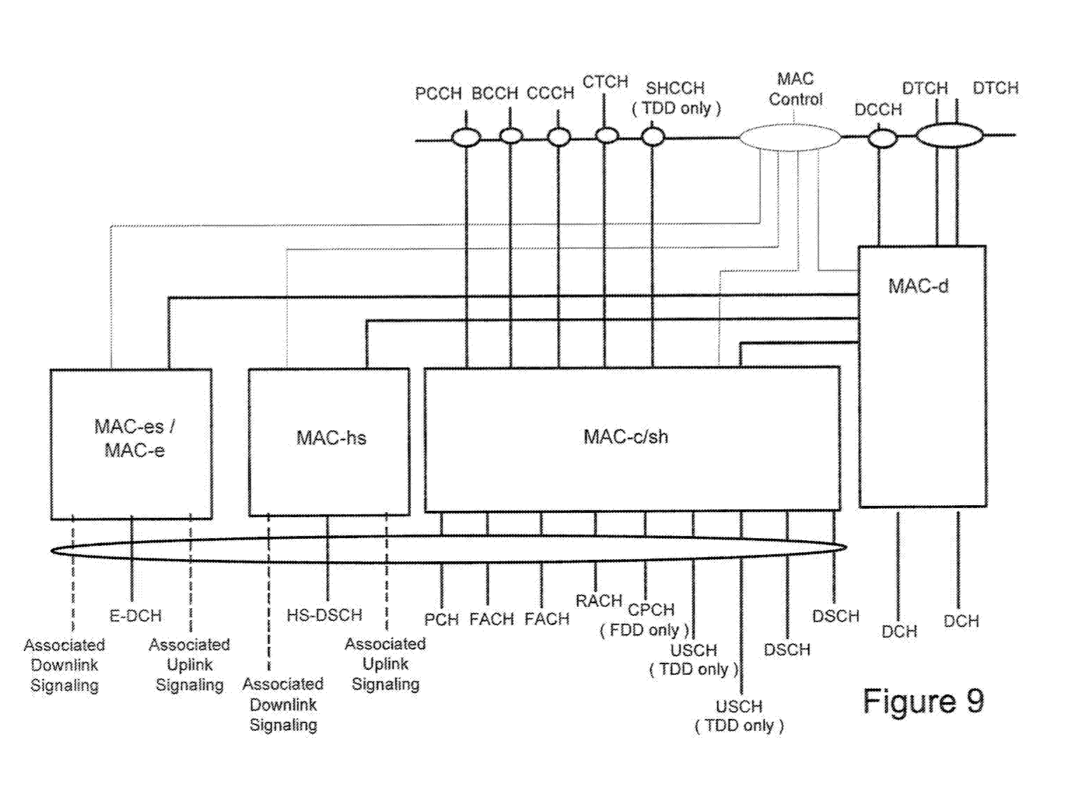

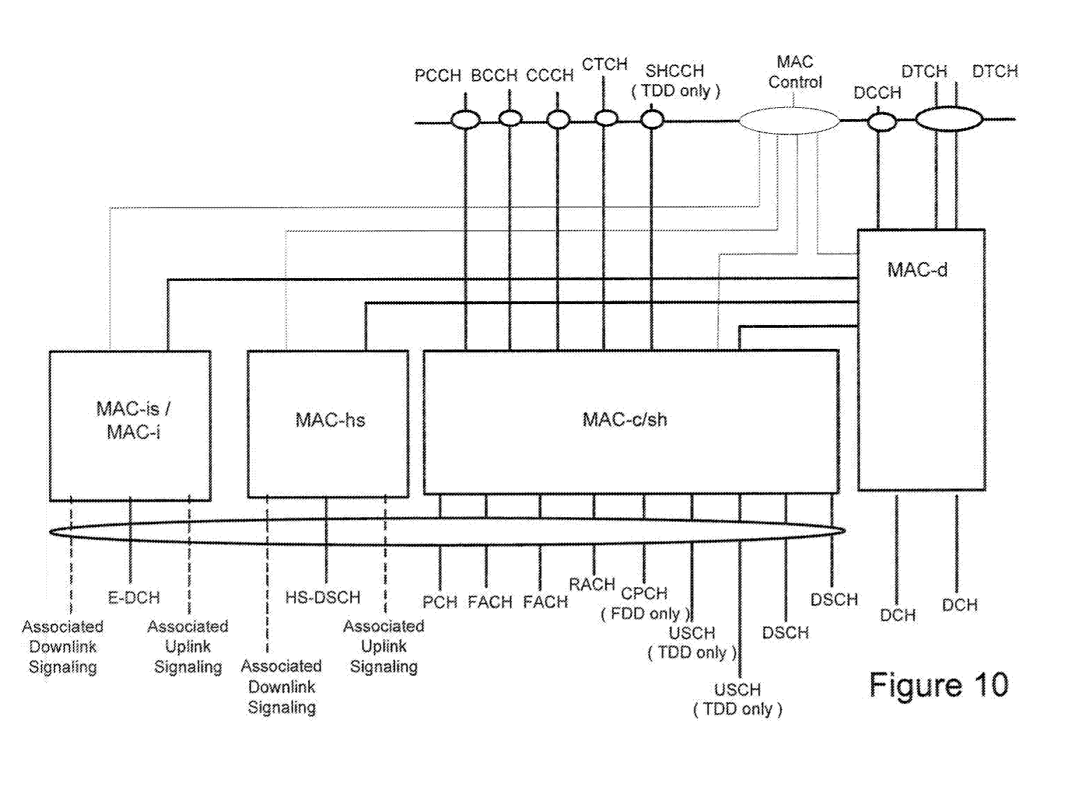

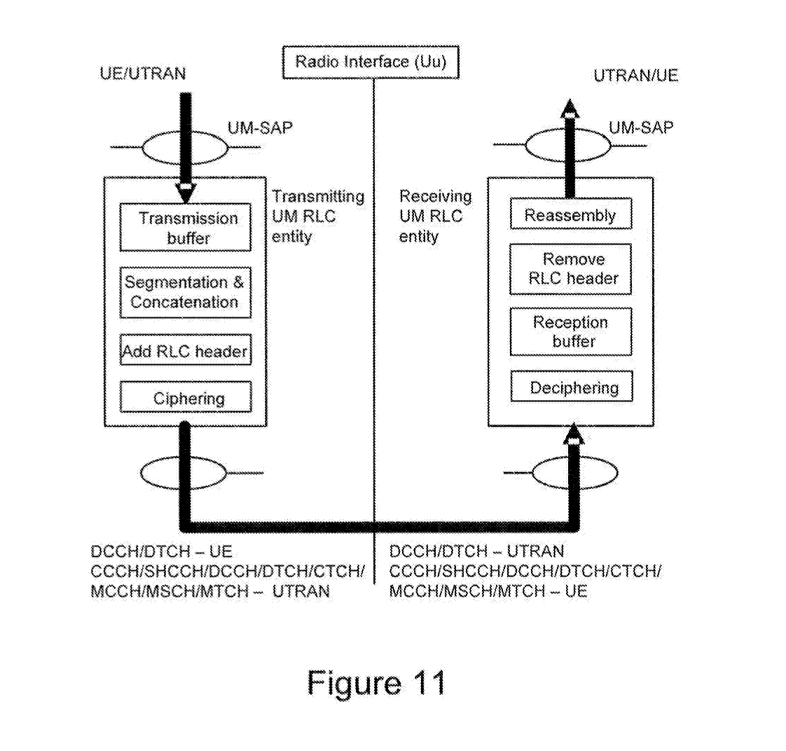

### DESCRIPTION OF NON-LIMITING EXAMPLE EMBODIMENTS

The following sets forth specific details, such as particular embodiments for purposes of explanation and not limitation. But it will be appreciated by one skilled in the art that other embodiments may be employed apart from these specific details. In some instances, detailed descriptions of well known methods, nodes, interfaces, circuits, and devices are omitted so as not obscure the description with unnecessary detail. Those skilled in the art will appreciate that the functions described may be implemented in one or more nodes using hardware circuitry and/or using software programs and data in conjunction with one or more digital microprocessors or general purpose computers. Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Individual function and flowchart blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), using one or more digital signal processors (DSPs), and using field programmable gate array(s) (FPGAs).

The software program instructions and data may be stored on computer-readable storage medium and when the instructions are executed by a computer or other suitable processor control, the computer or processor performs the functions, and (where appropriate) state machines capable of performing such functions.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred. A description of a process may be a description of an apparatus for performing the process. The apparatus that performs the process can include, e.g., a processor and those input devices and output devices that are appropriate to perform the process.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

Although the description is given for user equipment (UE), it should be understood by the skilled in the art that “UE” is a non-limiting term comprising any wireless device or node equipped with a radio interface allowing for at least one of: transmitting signals in UL and receiving and/or measuring signals in DL. Some examples of UE in its general sense are PDA, laptop, mobile, sensor, fixed relay, mobile relay, a radio network node (e.g., an LMU or a femto base station or a small base station using the terminal technology). A UE herein may comprise a UE (in its general sense) capable of operating or at least performing measurements in one or more frequencies, carrier frequencies, component carriers or frequency bands. It may be a “UE” operating in single- or multi-RAT or multi-standard mode.

A cell is associated with a base station, where a base station comprises in a general sense any node transmitting radio signals in the downlink (DL) and/or receiving radio signals in the uplink (UL). Some example base stations are eNodeB, eNB, Node B, macro/micro/pico radio base station, home eNodeB, relay, repeater, sensor, transmitting-only radio nodes or receiving-only radio nodes. A base station may operate or at least perform measurements in one or more frequencies, carrier frequencies or frequency bands and may be capable of carrier aggregation. It may also be a single-radio access technology (RAT), muti-RAT, or multi-standard node, e.g., using the same or different base band modules for different RATs.

The signaling described is either via direct links or logical links (e.g. via higher layer protocols and/or via one or more network nodes). For example, signaling from a coordinating node may pass another network node, e.g., a radio node.

The example embodiments are described in the non-limiting example context of a UTRAN type system. However, the technology is not limited to UTRAN, but may apply to any Radio Access Network (RAN), single-RAT or multi-RAT. Some other RAT examples are LTE-Advanced, UMTS, GSM, cdma2000, WiMAX, and WiFi. If applying the technology to LTE, for example, those skilled in the art will understand that the MAC entities in LTE have different names and functionalities.

The ciphering problem described in the background for UM RLC transmission/reception is preceded by the loss of a number of consecutive RLC PDUs (this number typically depends on the number of bits used to indicate the Sequence Number (SN). In the non-limiting example from the background, 7 bits are used, and thus, the number of lost consecutive data units might be 128 or more. But other smaller or larger numbers of lost consecutive PDUs may be used. The loss of consecutive PDUs can be detected by the MAC layer in case of transmission over HS-DSCH (for the downlink) and EUL (for the uplink). This mechanism may be implemented in the network side, in the UE side, or in both network and UE independently.

Consider the situation where the sequence number (SN) range is 128, i.e., from 0 to 127, and PDUs are transmitted and should be received in the same order. In other words, a PDU with a lower SN is transmitted and should be received before a PDU with a higher SN is received. But if the receiver receives a PDU with SN5 and thereafter receives a PDU with SN3, the technology provided by this application concludes that the 125 PDUs (127-5+3) have been lost (not received or correctly received) because the PDU with SN3 should not be received before the PDU with SN5. As a result, the HFN in the receiver may be incremented by one since the SN has “wrapped around.” But the number of lost PDUs need not necessarily be set to 128. Rather, it may for example be set to 20 in order to detect that something has or may have gone wrong to give the network and/or the UE an opportunity to action, if needed.

The network can detect the loss of consecutive UM RLC PDUs using one or more counters and/or timers in the MAC layer (e.g., in a MAC-hs controller or MAC-ehs controller). When the counters reach a specified value (e.g., hardcoded, defined during the set-up of the MAC and RLC entities, etc.), or at the expiration of one or more timers, an error detection notification is sent from the NodeB to the RNC for the downlink failures and for certain occurrences of uplink failure.

The UE may also detect the loss of consecutive UM RLC PDUs using one or more counters and/or timers in the MAC layer (e.g., in a MAC-e/es controller or MAC-i/is controller). When the counters reach a specified value (e.g., hardcoded, defined during the set-up of the MAC and RLC entities, etc.), or at the expiration of one or more timers, an error detection notification is sent from the UE to the RNC.

The network may use the notification received from the UE or the NodeB in order to correct an HFN de-sync error by re-aligning the frame numbers so that they are the same in both transmitting and receiving nodes.

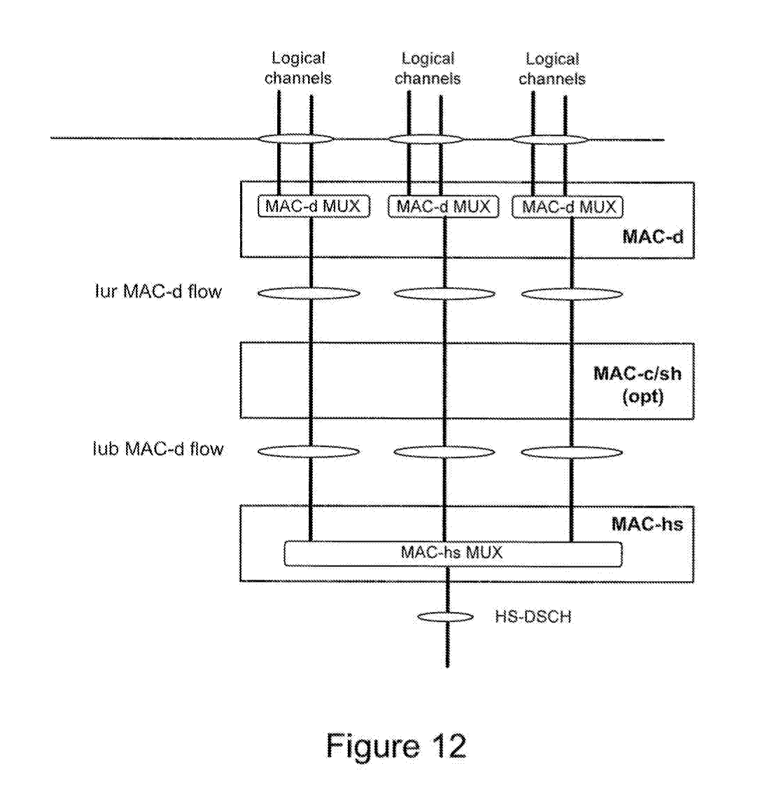

Another aspect of the technology this application addresses the fact that a UE radio bearer may include multiple data flow and/or logical channels that may need to be treated differently, e.g., different data flows have different quality of service parameters. This is illustrated in FIG. 12. While the method of mapping data to different priority queues in the NodeB differs between MAC-hs and MAC-ehs, there is commonality in that in both cases one or more logical channels may be mapped to each priority queue. This means that if more than one logical channel is mapped to a priority queue, then the NodeB will not be able to indicate which of the logical channels was affected by a HARQ failure when a NACK is received for a TTI in which data was sent from this particular priority queue. This presents a problems and undesired restrictions.

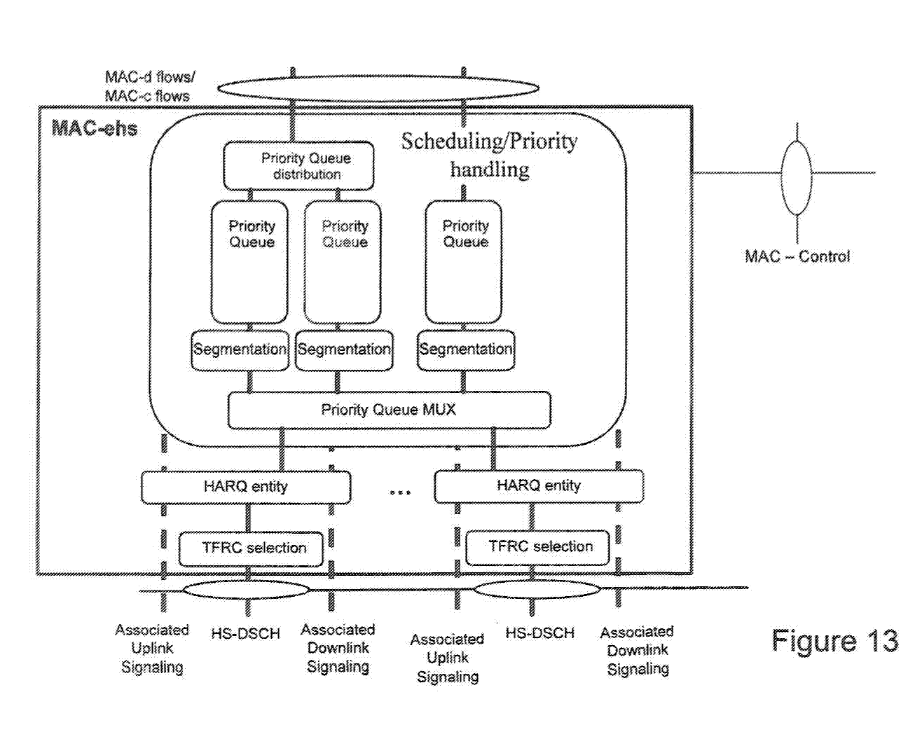

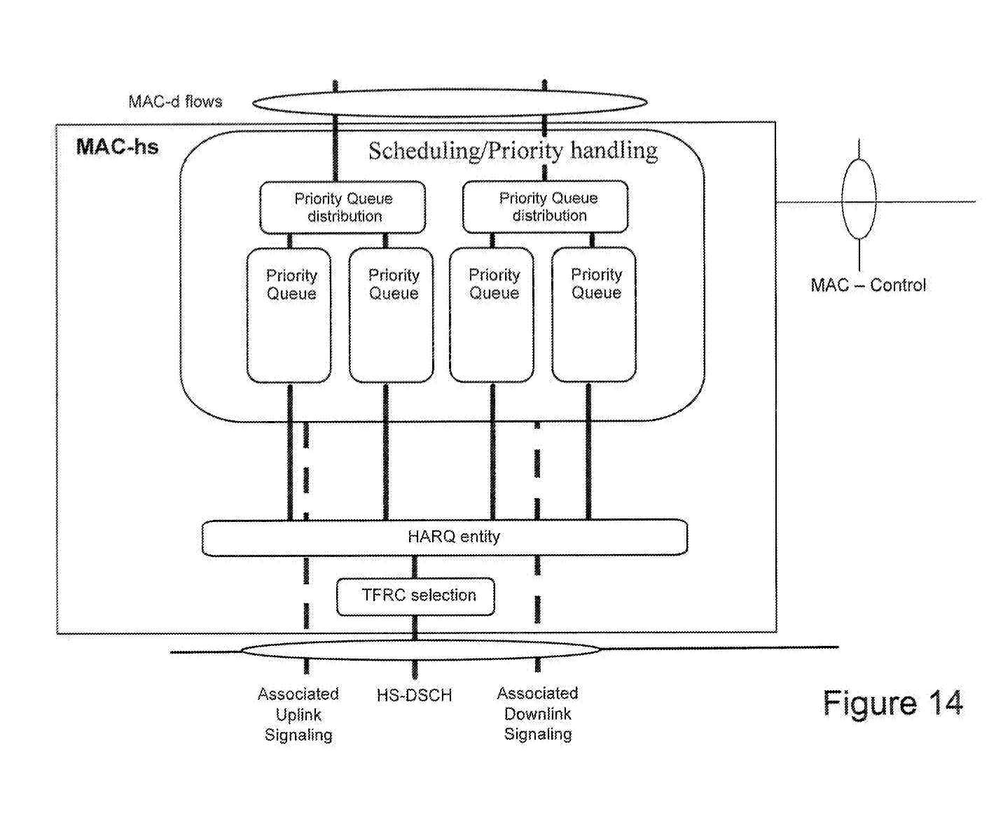

FIGS. 13 and 14 show multiple MAC-d and MAC-c flows and priority queues for MAC-ehs and MAC-hs.

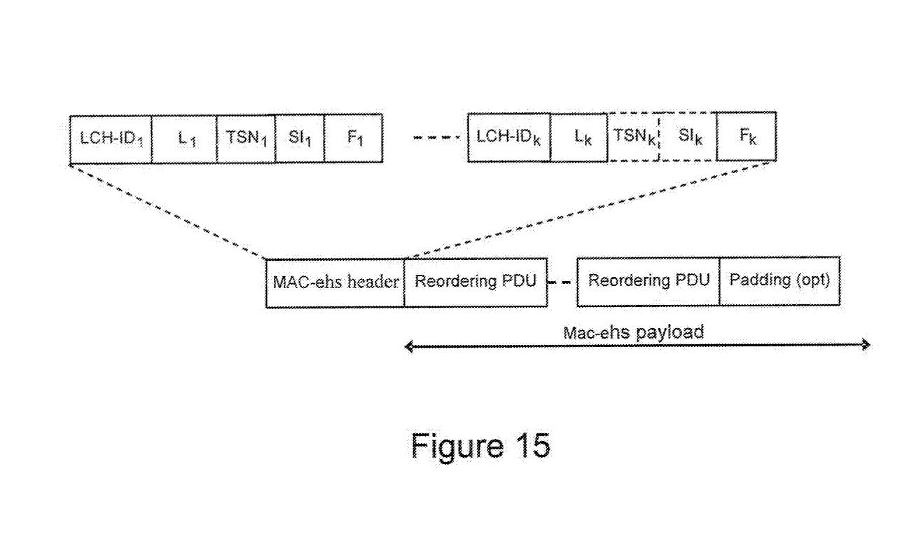

FIG. 15 shows an example MAC-ehs PDU with logical channel identifier (LCH-ID), Length (L), Transmission Sequence Number (TSN), Segmentation Indicator (SI), and Flag (F) fields.

Loss of data on the HARQ level is not a problem for RLC AM because such a loss of data causes an RLC retransmission which means that the RNC will be able to indirectly identify the logical channel that lost the data based on this information. However, for RLC UM, no such indication will be transmitted or received, and as a result, the data loss must be deduced implicitly based on the fact that a NACK was received for a TTI in which data from the priority queue to which the RLC UM data is mapped was scheduled. It would be instead beneficial for the network and/or for the UE to know whether this loss of consecutive PDUs (MAC and RLC) has an impact on a particular RLC entity (because this may determine a ciphering error if the transfer mode is UM) or on a particular logical channel (because different logical channels may be associated to different services which in turn may be more or less sensitive to a loss of PDUs). In accordance with example embodiments, the configuration for error detection (e.g., de-synchronization between the Node B and the UE) preferably depends on the transfer mode of RLC PDUs (i.e., UM, AM, or TM) and the specific and individual data flow and/or logical channel associated to those PDUs. Different transfer modes and different data flows and/or logical channels may need independent mechanisms, e.g., MAC counters and timers, in order to detect PDU loss per flow/logical channel.

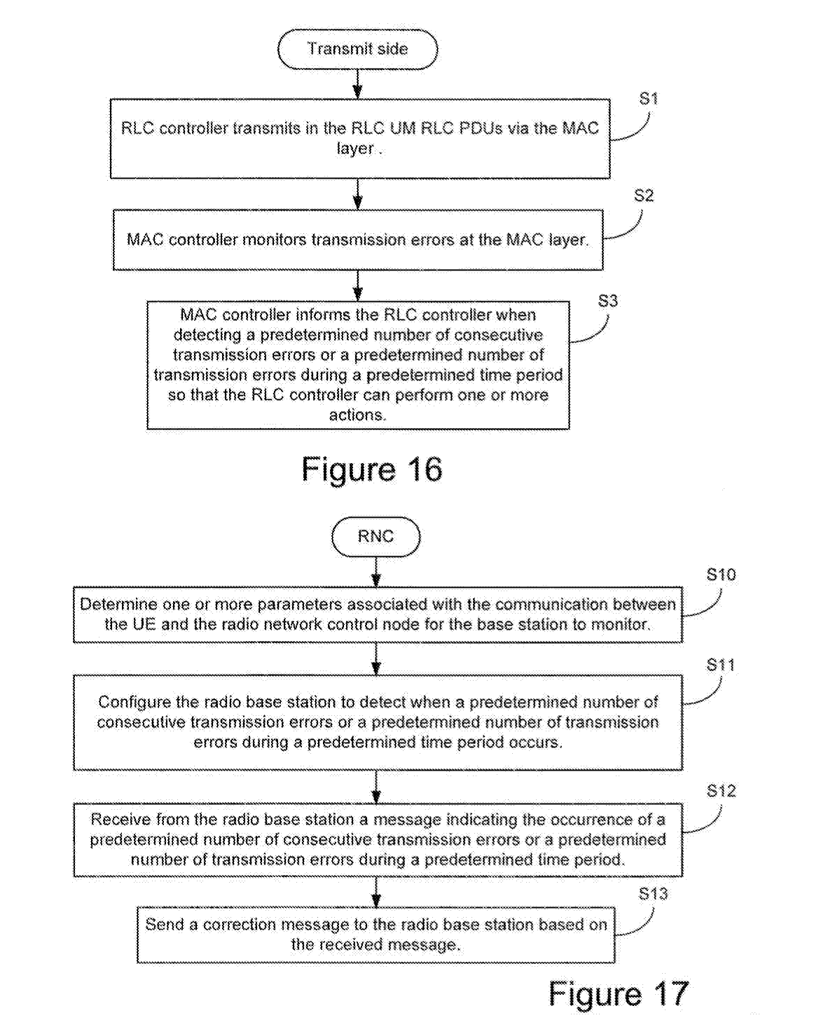

FIG. 16 is a flowchart diagram illustrating example procedures for carrying out a first non-limiting example embodiment. A transmitting node communicates with a receiving node using a multi-layer communications protocol having a lower media access control, MAC, layer and a higher radio link control, RLC, layer. An RLC controller operates in an RLC unacknowledged mode, RLC UM. A MAC controller operates using hybrid automatic repeat request, HARQ, for transmitted MAC protocol data units. The RLC controller in the RLC UM transmits RLC protocol data units via the MAC layer (step S1). The MAC controller monitors transmission errors at the MAC layer (step S2) and informs the RLC controller when detecting a predetermined number of consecutive transmission errors or a predetermined number of transmission errors during a predetermined time period so that the RLC controller can perform one or more actions (step S3).

FIG. 17 is a flowchart diagram illustrating example procedures for carrying out a second non-limiting example embodiment directed to a radio network control node, RNC, communicating with a user equipment, UE, via a radio base station over a radio interface using a multi-layer communications protocol having a lower media access control, MAC, layer and a higher radio link control, RLC, layer, where an RLC controller in the RNC operates in an RLC unacknowledged mode, RLC UM, and where a MAC controller in the base station operates using hybrid automatic repeat request, HARQ, for transmitted MAC data units. The RNC determines one or more parameters associated with the communication between the UE and the RNC for the base station to monitor (step S10). The RNC configures the radio base station to detect when a predetermined number of consecutive transmission errors or a predetermined number of transmission errors during a predetermined time period occurs (step S11). The RNC receives from the radio base station a message indicating the occurrence of a predetermined number of consecutive transmission errors or a predetermined number of transmission errors during a predetermined time period (step S12) and sends a correction message to the radio base station based on the received message (step S 13).

The description is now divided into three sections to allow focus on different example embodiments, applications, and variations. The technology in these sections may be used alone or in combination. The three sections include error detection, configuration and reporting of error detection, and correction of the error to maintain or reclaim synchronization between UE and the network.

Error Detection

The apparatus for error detection may be implemented in the UE and/or in one or more network nodes. If the error detection mechanism is configured in both the network node and the UE, then error detection mechanisms in the UE and the network node(s) may be different. Error detection in the UE is described in a first example context, and a second example context describes error detection in the network node.

For a first example implementation, error detection may be based on counter used by a MAC layer controller in the UE, if the UE is the transmitting node, and/or the network node if it is the transmitting node. MAC PDUs are communicated between MAC controllers in the UE and NodeB. RLC PDUs are communicated between RLC controllers in the UE and RNC. Error detection by a transmitting UE may be based on counter used by a MAC layer controller. When an RLC controller in the transmitting UE operates in Unacknowledged Mode, the MAC controller uses a counter to account for each transmission failure of a MAC PDU detected by the MAC controller in the transmitter. For the UE, when an RLC controller in the UE operates in Unacknowledged Mode, the MAC layer uses a counter to account for each transmission failure of a MAC PDU detected by the MAC controller. The counter may be initialized to an initial value equal to zero and incremented by one every time there is a transmission failure of a MAC PDU. If the counter is initialized to zero, a maximum value for the counter is also configured. If that maximum count value is reached, then the MAC controller sends an indication to the RLC controller that an error event has occurred, e.g., a loss of synchronization or de-synchronization between the UE transmitter and receiver. The maximum count value corresponds to the predetermined number of consecutive errors. Similarly, the counter may be initialized to a configurable, non-zero value which also corresponds to the predetermined number of consecutive errors. In this case, each time there is a transmission failure of a MAC PDU, the counter is decremented by one.

In either counter approach, the counter is reset if the transmission of a MAC PDU is successful. To reset means that the counter is initialized to 0 or to the value configured by the network depending on whether the counter increases or decreases after a detected transmission failure.

If the counter value is configured by the network, then this value can be conveyed to the MAC controller in the UE via radio resource control (RRC) signaling. Alternatively, this counter value can be hardcoded in the UE MAC controller. This alternative approach does not require any signaling between the RNC and UE.

In this situation, the transmitter and the receiver each include configured HARQ controllers. The transmission of a MAC PDU is considered successful if the HARQ controller in the UE receives a positive acknowledgement from the network for that MAC PDU. If the transmission of a MAC PDU is not successful, then the UE re-transmits the MAC PDU if configured by the network to retransmit. A transmission failure occurs when the maximum number of HARQ transmissions (which includes the initial transmission and any retransmissions) for a MAC PDU is reached. The receiver, upon receiving a MAC PDU, sends a positive acknowledgement for that MAC PDU if it was successfully received or a negative acknowledgement for that MAC PDU if it was unsuccessfully received (not received or received in error). In this example context, a MAC PDU refers to a MAC-e/es or MAC-i/is PDU for the uplink.

An example implementation of the first embodiment with error detection by a transmitting network is now described. When a Radio Link Control controller in the RNC is configured in order to operate in Unacknowledged Mode, the MAC layer in the transmitting NodeB includes a counter that is used to account for each transmission failure of a MAC PDU detected by the MAC controller. The counter may be initialized to an initial value equal to zero and incremented by one every time there is a transmission failure of a MAC PDU. If the counter is initialized to zero, a maximum value for the counter is also configured. If that maximum count value is reached, then the MAC controller sends an indication to the RLC controller that an error event has occurred, e.g., a loss of synchronization or de-synchronization between the transmitter and UE receiver. The maximum count value corresponds to the predetermined number of consecutive errors. Similarly, the counter may be initialized to a configurable, non-zero value which also corresponds to the predetermined number of consecutive errors. In this case, each time there is a transmission failure of a MAC PDU, the counter is decremented by one.

If the counter value is configured by the network, this value can be conveyed to the MAC controller in the NodeB via Node B Application Part (NBAP) signaling. Alternatively, this value can be a hardcoded parameter in the MAC controller of the NodeB. This alternative approach does not require any signaling between the RNC and UE.

The transmission of a MAC PDU is considered successful if the HARQ controller in the network receives a positive acknowledgement from the UE for that MAC PDU. If the transmission of a MAC PDU is not successful, then the network node may re-transmit the MAC PDU. A transmission failure is considered when the network decides to stop re-transmitting that MAC PDU. The previous assumptions are based on the fact that the transmitter and the receiver have configured HARQ entities. The receiver, upon receiving a MAC PDU, should then send a positive acknowledgement for that MAC PDU if it was successfully received or a negative acknowledgement for that MAC PDU if it was unsuccessfully received. In this example context, a MAC PDU refers to a MAC-hs or MAC-ehs PDU for the downlink.

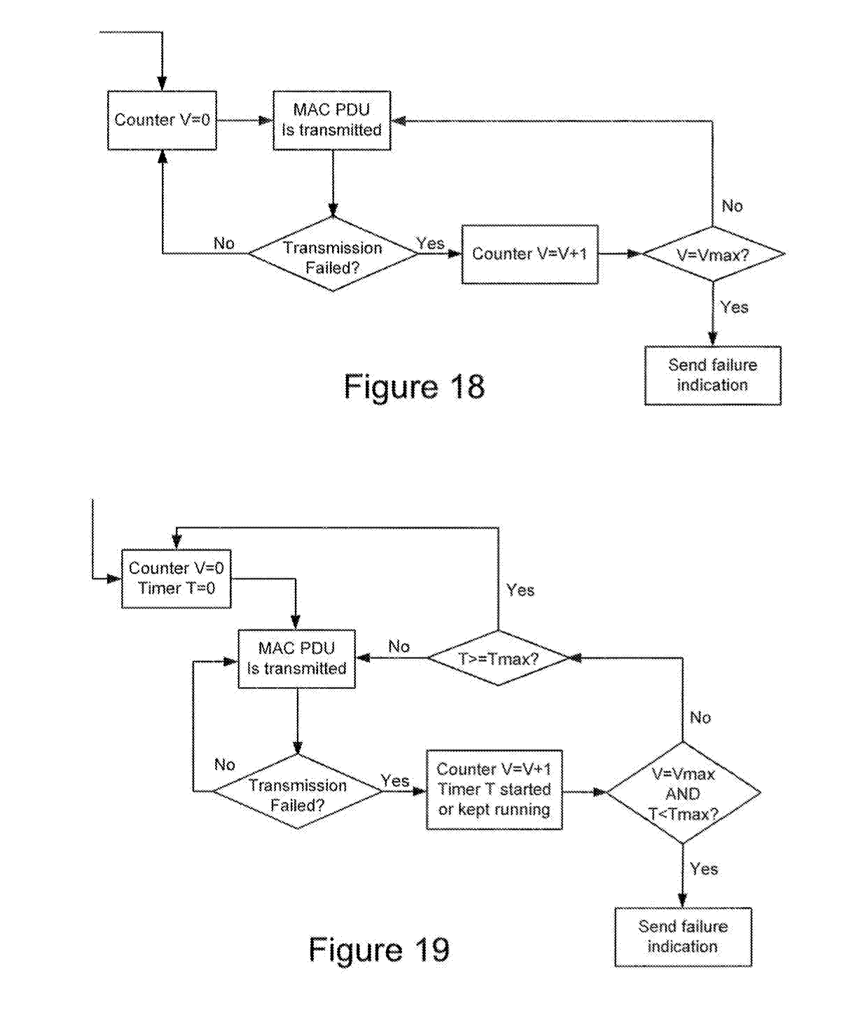

The following example procedure may be implemented in either or both the UE and network node(s). When the incremented counter reaches its maximum value, the Medium Access Control controller sends an error indication to one or more higher layers, e.g., the RLC layer. Alternatively, if a decrementing counter is used, and it reaches its minimum value (i.e., 0), the MAC controller sends an error indication to one or more higher layers. This error indication may trigger one or more higher protocol layer procedures. FIG. 18 is a flowchart that illustrates an example implementation for an incrementing counter.

In a second example implementation, error detection is based on a counter and a timer. FIG. 19 is a flowchart that illustrates example procedures for a counter-timer implementation. When both AM and UM PDUs are transmitted, then it is possible for non-consecutive HARQ failures to occur, but to still have consecutive failures occur for MAC PDUs carrying UM RLC PDUs. A timer is used so that the counter is not reset in this situation. For example, a first MAC PDU contains only an RLC UM PDU, the seconds MAC PDU contains only an RLC AM PDU, and the third MAC PDU contains only an RLC UM PDU. The first and third MAC PDUs are not transmitted successfully, but the second is transmitted successfully. In this situation, there are non-consecutive HARQ failures but still consecutive failures for MAC PDUs carrying UM RLC PDUs. The transmitter does not have the intelligence to understand if the HARQ failures are related to AM or UM RLC PDUs. But this situation may be detected using a timer and a counter.

Consider an example including error detection by a transmitting UE. The function of the counter is to account for each transmission failure of a MAC PDU. The function of the timer is to account for a maximum time frame under which the MAC PDU transmission failures are counted.

When an RLC controller operates in Unacknowledged Mode, the MAC layer uses a counter to account for each transmission failure of a MAC PDU detected by the MAC controller. The counter may be initialized to an initial value equal to zero and incremented by one every time there is a transmission failure of a MAC PDU. If the counter is initialized to zero, a maximum value for the counter is also configured. If that maximum count value is reached, then the MAC controller sends an indication to the RLC controller that an error event has occurred, e.g., a de-synchronization between the transmitting UE and receiver. The maximum count value corresponds to the predetermined number of consecutive errors. Alternatively, the counter may be initialized to a configurable, non-zero value which also corresponds to the predetermined number of consecutive errors. In this case, each time there is a transmission failure of a MAC PDU, the counter is decremented by one.

The timer may for example be configured with a timer value by the network and signaled to the UE or the timer value may be hardcoded in the UE. The timer value indicates when the timer expires. The timer is started when there is a transmission failure of a MAC PDU. The timer is reset at its expiration and is not re-started due to subsequent failures. The counter is reset at the expiration of the timer. To reset means that the counter is initialized to 0 or to the value configured by the network depending on whether the counter increases or decreases after a failure.

If the counter value or maximum counter value is configured by the network, this value can be conveyed to the MAC controller in the UE via RRC signaling. Otherwise, this value can be hardcoded in the MAC controller of the UE. The latter approach does not require signaling between the RNC and UE.

In this situation, the UE transmitter and the NodeB receiver each include configured HARQ controllers. The transmission of a MAC PDU is considered successful if the HARQ controller in the UE receives a positive acknowledgement from the network for that MAC PDU. If the transmission of a MAC PDU is not successful, then the UE re-transmits the MAC PDU if configured by the network to retransmit. A transmission failure occurs when the maximum number of HARQ transmissions (which includes the initial transmission and any retransmissions) for a MAC PDU is reached. The NodeB receiver, upon receiving a MAC PDU, sends a positive acknowledgement for that MAC PDU if it was successfully received or a negative acknowledgement for that MAC PDU if it was unsuccessfully received (not received or received in error). In this example context, a MAC PDU refers to a MAC-e/es PDU or a MAC-i/is PDU for the uplink.

Consider an example including error detection by a transmitting network. When an RLC controller in the RNC is configured in order to operate in Unacknowledged Mode, the MAC controller in the NodeB is configured with a counter and a timer. The function of the counter is to account for each transmission failure of a MAC PDU. The function of the timer is to account for a maximum time frame under which the MAC PDU transmission failures are counted.

The counter may be initialized to an initial value equal to zero and incremented by one every time there is a transmission failure of a MAC PDU. If the counter is initialized to zero, a maximum value for the counter is also configured. If that maximum count value is reached, then the MAC controller sends an indication to the RLC controller that an error event has occurred, e.g., a de-synchronization between the NodeB transmitter and UE receiver. The maximum count value corresponds to the predetermined number of consecutive errors. Similarly, the counter may be initialized to a configurable, non-zero value which also corresponds to the predetermined number of consecutive errors. In this case, each time there is a transmission failure of a MAC PDU, the counter is decremented by one.

The timer may for example be configured with a timer value by the network or the timer value may be hardcoded. The timer value indicates when the timer expires. The timer is started when there is a transmission failure of a MAC PDU. The timer is reset at its expiration and is not re-started due to subsequent failures. The counter is reset at the expiration of the timer. Again, to reset means that the counter is initialized to 0 or to the value configured by the network depending on whether the counter increases or decreases after a failure.

If the counter value is configured by the network, this value can be conveyed to the MAC controller in the NodeB via NBAP signaling or this value can be a hardcoded parameter in the MAC controller of the NodeB. The latter approach does not require signaling between RNC and NodeB. If the timer value is configured by the network, this value can be conveyed to the MAC controller in the Node-B via NBAP signaling. Alternatively, this value can be a hardcoded parameter in the MAC controller of the NodeB. The latter approach does not require signaling between RNC and NodeB.

In this situation, the transmitter and the receiver each include configured HARQ controllers. The transmission of a MAC PDU is considered successful if the HARQ controller in the transmitter receives a positive acknowledgement from the receiver for that MAC PDU. If the transmission of a MAC PDU is not successful, then the transmitter re-transmits the MAC PDU if configured by the network to retransmit. A transmission failure occurs when the maximum number of HARQ transmissions (which includes the initial transmission and any retransmissions) for a MAC PDU is reached. The receiver, upon receiving a MAC PDU, sends a positive acknowledgement for that MAC PDU if it was successfully received or a negative acknowledgement for that MAC PDU if it was unsuccessfully received (not received or received in error). In this example context, a MAC PDU refers to a MAC-hs PDU or a MAC-ehs PDU for the downlink.

The following example procedure may apply to one or both of the UE and network node(s). When the counter is incremented and reaches its maximum value, the MAC controller sends an error indication to one or more higher protocol layers, e.g., an RLC controller. Similarly, if the decrementing counter is used and reaches its minimum value (i.e., 0), the MAC controller sends an error indication to one or more higher layers. FIG. 19 is a flowchart that illustrates example procedures for a counter-timer implementation.

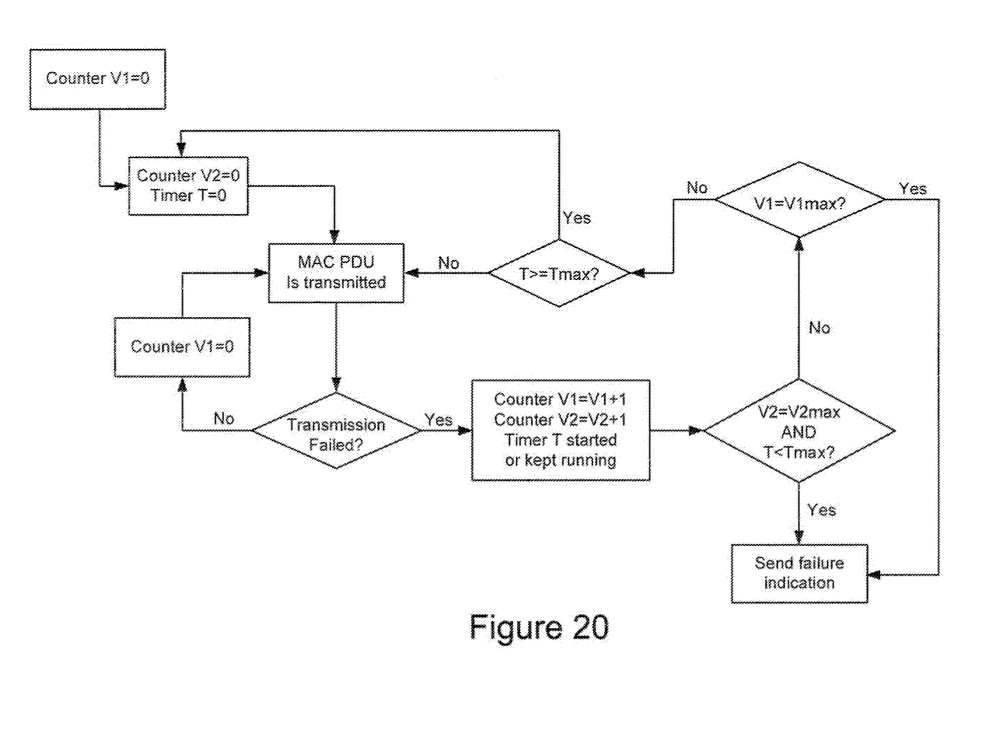

A third example implementation performs error detection using two counters and a timer. FIG. 20 is a flowchart that illustrates example procedures for a two counter-one timer implementation. For error detection by the UE when an RLC controller operates in Unacknowledged Mode, the MAC layer employs two counters and a timer. The two counters account for each transmission failure of a MAC PDU, and the timer accounts for a maximum time period during which the MAC PDU transmission failures are counted. As above, MAC PDU in this example context refers to a MAC-e/es PDU or a MAC-i/is PDU for the uplink. The first and second counters count both consecutive and non-consecutive failures. For example, error detection might be triggered when either (1) 10 consecutive failures are detected or (2) 20 failures are detected within a time frame of 40 msec.

The first counter may be initialized to an initial value equal to zero and incremented by one every time there is a transmission failure of a MAC PDU. If the counter is initialized to zero, then a maximum value for the counter may also be configured. Alternatively, the first counter may be initialized to a configurable non-zero value. Each time there is a transmission failure of a MAC PDU, the counter is decremented by one. The first counter is reset if the transmission of a MAC PDU is successful. If the first counter value is configured by the network, that value may be conveyed to the MAC controller in the UE via RRC signaling. Alternatively, this value can be hardcoded in the MAC controller of the UE which does not require signaling between an RNC and the UE.

The second counter may be initialized to zero and incremented by one every time there is a transmission failure of a MAC PDU up to a maximum value configured for the second counter. Alternatively, the second counter may be initialized to a configurable non-zero value. The timer is either configured by the network and then signaled to the UE, or hardcoded in the UE. The timer value indicates when the timer expires. The timer is started when there is a failure in the transmission of a MAC PDU. The timer is reset at expiration. The timer is not re-started due to subsequent failures. The second counter is reset at the expiration of the timer. If the second counter value is configured by the network, this value can be conveyed to the MAC controller in the UE via RRC signaling. Alternatively, the value can be hardcoded in the MAC controller of the UE which avoids the need for signaling between RNC and UE.

For error detection in this third embodiment by the network node when an RLC controller in the RNC is configured in order to operate in Unacknowledged Mode, the MAC controller in the NodeB is configured with two counters and a timer. The first counter may be initialized to an initial value equal to zero and incremented by one every time there is a transmission failure of a MAC PDU. In this example context, MAC PDU refers to a MAC-hs PDU or a MAC-ehs PDU for the downlink. If the first counter is initialized to zero, a maximum value for the counter is also configured. Alternatively, the counter may be initialized to a configurable non-zero value, and each time there is a transmission failure of a MAC PDU, the counter is decremented by one. The first counter is reset if the transmission of a MAC PDU is successful. If the first counter value is configured by the network, this value can be conveyed to the MAC controller in the NodeB via NBAP signaling. Alternatively, this value can be a hardcoded parameter in the MAC controller of the NodeB which avoids the need for signaling between RNC and NodeB.

The second counter may be initialized to an initial value equal to zero and incremented by one every time there is a transmission failure of a MAC PDU. If the second counter is initialized to zero, a maximum value for the counter is also configured. Alternatively, the second counter may be initialized to a configurable non-zero value, and each time there is a transmission failure of a MAC PDU, the counter is decremented by one. The configured value for the timer indicates when the timer expires. The timer is started when there is a transmission failure of a MAC PDU. The timer is reset at its expiration and is not re-started due to subsequent failures. The second counter is reset at the expiration of the timer.

If the second counter value is configured by the network, this value can be conveyed to the MAC controller in the NodeB via NBAP signaling or this value can be a hardcoded parameter in the MAC controller of the NodeB which means that signaling between RNC and NodeB is not required. If the timer value is configured by the network, this value can be conveyed to the MAC controller in the NodeB via NBAP signaling or this value can be a hardcoded parameter in the MAC controller of the NodeB.

The procedures shown in FIG. 20 can apply to either or both of the UE and network node for this example embodiment. If the first counter or the second counter (or both of them) is incremented, and the counter reaches its maximum value, the MAC controller sends an indication to one or more higher protocol layers, e.g., an RLC controller, to trigger higher layer procedures. If the first counter or the second counter (or both of them) is decremented, and the counter reaches its minimum value (i.e., 0), then the MAC controller sends an indication to one or more higher protocol layers, e.g., an RLC controller, to trigger higher layer procedures.

In a fourth example embodiment, error detection is based on a timer. In an example where error detection is done by the UE, with an RLC controller configured to operate in Unacknowledged Mode, the MAC controller includes a timer. The function of the timer is to account for a maximum time period under which the MAC PDU transmission failures occur without a successful transmission. The timer may for example be configured by the network via RRC signaling or hardcoded in the UE. The timer value indicates when the timer expires. Assuming that data is sent periodically (e.g. as for Voice over IP) or that there will be a least a predetermined number of MAC PDU transmissions, the timer is started when there is a transmission failure of a MAC PDU. The timer is reset when there is a successful transmission of a MAC PDU. The timer need not be re-started for subsequent failures. In this example context, a MAC PDU refers to a MAC-e/es PDU or a MAC-i/is PDU for the uplink.

In an example where error detection is done by a network node, the RLC controller in the RNC is configured to operate in Unacknowledged Mode, and the MAC controller in the NodeB includes a timer like that just described for the UE. If the timer value is configured by the network, this value can be conveyed to the MAC controller in the NodeB via NBAP signaling. Alternatively, this value can be a hardcoded parameter in the MAC controller of the NodeB which means that signaling between RNC and NodeB is not needed. In this example context, a MAC PDU refers to a MAC-hs PDU or aMAC-ehs PDU for the downlink.

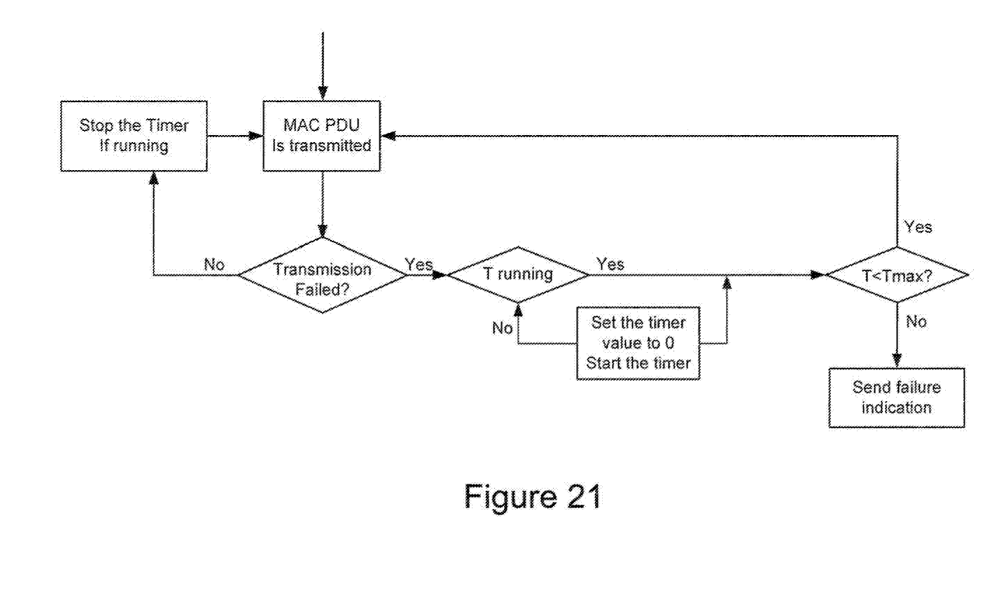

FIG. 21 is a flowchart that illustrates example procedures for a timer implementation for either or both of the UE and network node(s). If the timer expires (reaches its maximum value), the MAC controller sends an indication to one or more higher protocol layers, e.g., the RLC controller. This indication may be used to trigger one or more higher layer procedures.

Configuration and Reporting of Error Detection.

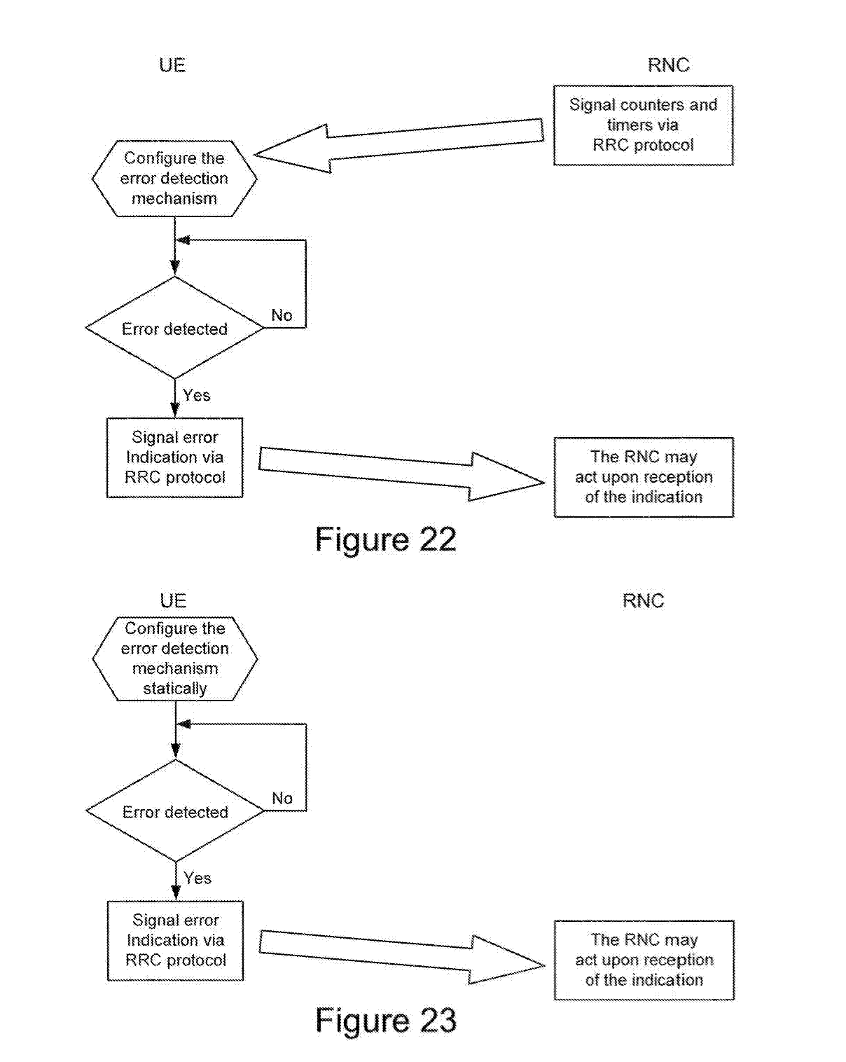

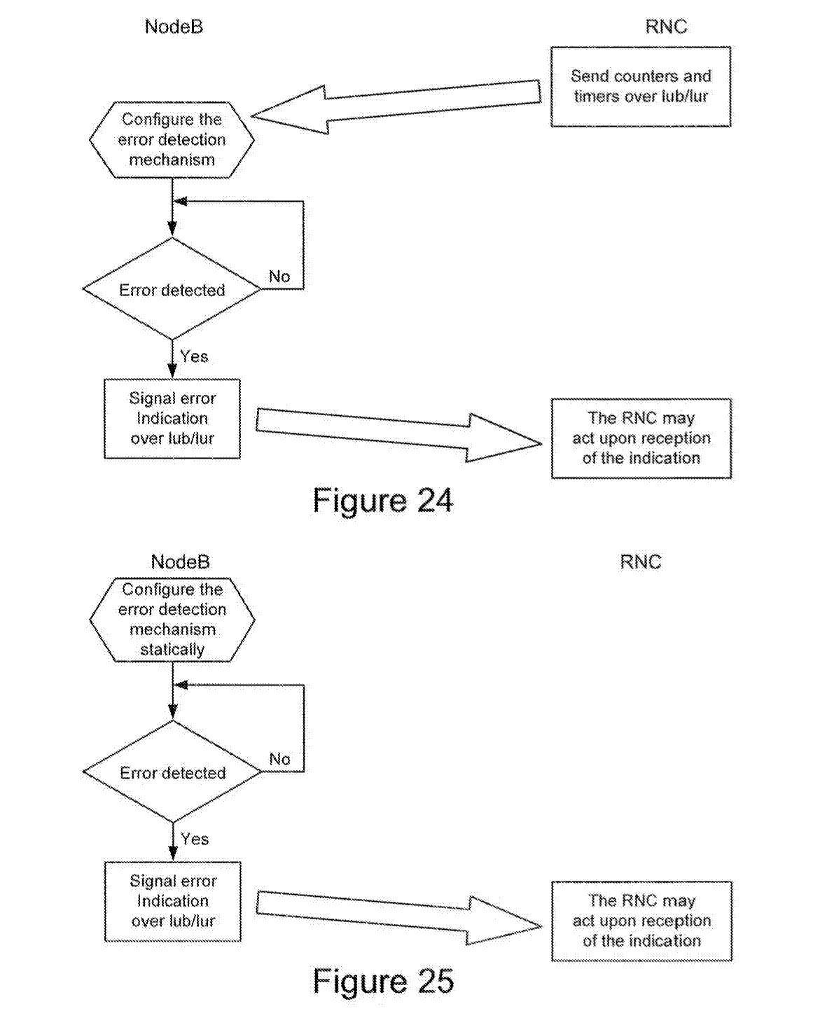

FIGS. 22-25 are flowcharts that illustrate example procedures for configuring the NodeB and UE to perform error detection and correction. FIG. 22 shows the RNC signaling counter and/or timer values to a UE to configure error detection which the UE then performs and signals an error indication back to the RNC to allow the RNC to take one or more corrective actions. Alternatively, FIG. 23 shows an example where the UE is statically configured. FIG. 24 shows the RNC signaling counter and/or timer values to a NodeB to configure error detection which the NodeB then performs and signals an error indication back to the RNC to allow the RNC to take one or more corrective actions. Alternatively, FIG. 25 shows an example where the NodeB is statically configured.

In example embodiments, the NodeB may execute independent instances of the error detection algorithm(s) described above to detect loss of DL MAC PDUs. Each instance of an error detection algorithm may be associated to a different MAC-d flows, priority queue, and/or logical channel identity. Each error detection instance may use different counters and/or timers depending on the implementation. The NodeB preferably signals the error detection associated to each instance independently to the RNC.

Thus, for example, a NodeB indicates loss of DL MAC PDUs for each priority queue in the NodeB. If there is a one to one mapping of logical channels to priority queues, then there is a direct identification to the RNC of which logical channel is affected, and consequently, loss of data for a particular logical channel can be determined as a certainty. Given priority considerations for typical data mapped to RLC UM like VoIP or real time video, RLC UM data in a typical implementation may be mapped to an exclusive priority queue, thereby permitting direct identification of PDU losses of RLC UM data. This reduces the risk of transmit sequence number (TSN) wrap around.

If more than one logical channel is mapped to a particular priority queue, then the behavior is implementation dependent, and the RNC may either choose to assume that RLC UM data has been lost or not. In this case, the RNC may choose not to act on the information received or more conservatively estimate that the data lost from the priority queue stems from the logical channel most susceptible to TSN wrap around, i.e., the logical channel conveying RLC UM data. Since the RNC knows the mapping logical channels to MAC-d flows and to Priority Queues for MAC-hs and Queue id for MAC-ehs, the RNC has sufficient information to determine if the functionality described above should be triggered or not for an individual data flow.

RNC Configuration.

In example embodiments, when configuring a Radio Bearer and the relevant RLC entities and MAC-d flows, MAC reordering queues, and Logical Channel IDs, information signaled from the RNC to both the NodeB and UE is used for the configuration detection. For example, the RNC may signal up to 8 RB multiplexing options (maxRBMuxOptions). For each multiplexing option, the RNC may provide Downlink RLC logical channel information. For each Downlink RLC logical channel, (e.g., up to 2 per RLC entity or radio bearer), the RNC provides either MAC-hs or MAC-ehs header type information. For MAC-hs, the DL HS-DSCH MAC-d flow identity (0 to 7) may be provided, and for MAC-ehs, a DL HS-DSCH MAC-ehs Queue Id (0 to 7) and optionally a logical channel identity (1 to 15) may be provided. The RNC may provide the HS-DSCH MAC-d flow identity (0 to 7).

One non-limiting example is provided below. Either priority queue ID, HS-DSCH MAC-d Flow ID, logical channel ID, or a subset of these parameters is selected. The RNC configures a de-sync counter and/or timer for each HS-DSCH MAC-d flow ID and/or priority queue and/or logical channel ID. This configuration information is provided to and used in the Node B.

The technology may for example be applied to the NBAP (TS 25.433)/RNSAP (25.423) control plane by adding into an existing message or by creating a new dedicated message. One example of a configuration IE is given in Table 1 below.

TABLE 1

| | Pre- | | IE Type and | Semantics |
|---|---|---|---|---|
| IE/Group Name | sence | Range | Reference | Description |
| De-sync detection | 1..8 | | | A loop to max 8 for |
| configuration | | | | example |
| >Priority Queue | O | | INTEGER | Indicates the Priority |
| ID | | | (0..7) | Queue ID |
| >HS-DSCH | M | | INTEGER | Indicates the HS-DSCH |
| MAC-d | | | (0..7) | MAC-D associated |
| flow ID | | | | with the Priority Queue |
| >logical channel ID | O | | INTEGER | Indicates the logical |
| | | | (1..15) | channel |
| >DL RLC | O | | ENUMER- | downlink RLC PDU |
| PDU | | | ATED ( | size format used for |
| Size Format | | | Fixed RLC | a Priority Queue |
| | | | PDU size, | |
| | | | Flexible RLC | |
| | | | PDU | |
| | | | size,...) | |
| >RLC Mode | M | | ENUMER- | RLC Mode used for |
| | | | ATED ( | the Priority Queue |
| | | | RLC-AM, | |
| | | | RLC- | |
| | | | UM,RLC- | |
| | | | TM,...) | |
| >De-sync | M | | INTEGER | Configures a Counter |
| detect Counter | | | (0..XX) | for Node B de-sync |
| | | | | detection |
| >De-sync | M | | INTEGER | Configures a Timer for |
| detect Timer | | | (0..YY) | Node B de-sync |
| | | | | detection |

In the Table 2 example below, new Information Elements (IEs) for HFN de-synchronization (de-sync) configuration are added on NBAP by adding the new configuration IEs to the existing IE HS-DSCH MAC-d Flow Information. This IE may be included in dedicated Radio Link handling messages “RADIO LINK SETUP REQUEST/RADIO LINK ADDITION REQUEST/RADIO LINK RECONFIGURATION PREARE/RADIO LINK RECONFIGURATION REQUEST” in NBAP and RNSAP.

The HS-DSCH MAC-d Flows Information IE is used for the establishment of HS-DSCH MAC-d flows for a UE Context.

TABLE 2

| | | | IE Type and | Semantics | | Assigned |
|---|---|---|---|---|---|---|
| IE/Group Name | Presence | Range | Reference | Description | Criticality | Criticality |
| HS-DSCH MAC-d Flow | | 1 . . . <maxNrOfMACdFlows> | | | — | |
| Specific Information | | | | | | |
| >HS-DSCH MAC-d Flow | M | | 9.2.1.30O | | — | |
| ID | | | | | | |
| >Allocation/Retention | M | | 9.2.1.1 | | — | |
| Priority | | | | | | |
| >Traffic Class | M | | 9.2.1.58A | | — | |
| >Binding ID | O | | 9.2.1.3 | Shall be | — | |
| | | | | ignored if | | |
| | | | | bearer | | |
| | | | | establishment | | |
| | | | | with ALCAP. | | |
| >Transport Layer | O | | 9.2.1.62 | Shall be | — | |
| Address | | | | ignored if | | |
| | | | | bearer | | |
| | | | | establishment | | |
| | | | | with ALCAP. | | |
| >TNL QoS | O | | 9.2.1.56A | Shall be | YES | ignore |
| | | | | ignored if | | |
| | | | | bearer | | |
| | | | | establishment | | |
| | | | | with ALCAP. | | |
| >TrCH Source Statistics | O | | 9.2.1.65 | | YES | ignore |
| Descriptor | | | | | | |
| >HFN de-synchronization | O | | 9.2.X.Y | | YES | ignore |
| detection Configuration | | | | | | |
| Priority Queue | | 1 . . . <maxNrOfPrioQueues> | | | — | |
| Information | | | | | | |
| >Priority Queue ID | M | | 9.2.1.45A | | — | |
| >Associated HS-DSCH | M | | HS-DSCH | The HS-DSCH | — | |
| MAC-d Flow | | | MAC-d Flow | MAC-d Flow ID | | |
| | | | ID | shall be one of | | |
| | | | 9.2.1.30O | the flow IDs | | |
| | | | | defined in the | | |
| | | | | HS-DSCH | | |
| | | | | MAC-d Flow | | |
| | | | | Specific | | |
| | | | | Information of | | |
| | | | | this IE. | | |
| | | | | Multiple Priority | | |
| | | | | Queues can be | | |
| | | | | associated with | | |
| | | | | the same HS- | | |
| | | | | DSCH MAC-d | | |
| | | | | Flow ID. | | |
| >Scheduling Priority | M | | 9.2.1.51A | | — | |
| Indicator | | | | | | |
| >T1 | M | | 9.2.1.54A | | — | |
| >Discard Timer | O | | 9.2.1.19C | | — | |
| >MAC-hs Window Size | M | | 9.2.1.34C | | — | |
| >MAC-hs Guaranteed Bit | O | | 9.2.1.34Aa | | — | |
| Rate | | | | | | |
| >MAC-d PDU Size | | 1 . . . <maxNrOfPDUIndexes> | | | — | |
| Index | | | | | | |
| >>SID | M | | 9.2.1.52D | Shall be | — | |
| | | | | ignored if | | |
| | | | | Maximum | | |
| | | | | MAC-d PDU | | |
| | | | | Size extended | | |
| | | | | IE is present. | | |
| >>MAC-d PDU Size | M | | 9.2.1.34A | Shall be | — | |
| | | | | ignored if | | |
| | | | | Maximum | | |
| | | | | MAC-d PDU | | |
| | | | | Size extended | | |
| | | | | IE is present. | | |
| >RLC Mode | M | | 9.2.1.48D | | — | |
| >Maximum MAC-d PDU | O | | MAC PDU | | YES | reject |
| Size extended | | | Size | | | |
| | | | Extended | | | |
| | | | 9.2.1.34D | | | |
| >DL RLC PDU Size | O | | 9.2.1.136 | | YES | ignore |
| Format | | | | | | |
| >UE Aggregate Maximum | O | | NULL | | YES | ignore |
| Bit Rate Enforcement | | | | | | |
| Indicator | | | | | | |

The IE HFN de-synchronization detection Configuration is defined as in below Table 3. The HFN de-synchronization detection Configuration IE provides information for a Node B or drift RNS (DRNS) to perform HFN de-synchronization detection.

TABLE 3

| | | | IE Type | |
|---|---|---|---|---|
| IE/Group | Pre- | | and | |
| name | sence | Range | Reference | Semantic Description |
| De-sync | M | | INTEGER | 0 means that the Counter is |
| detect Counter | | | (0..8191,...) | not used |
| De-sync | M | | INTEGER | Unit: ms; |
| detect Timer | | | (0..8191,...) | 0 means that the Timer is not |
| | | | | used. |
| | | | | When both De-sync detect |
| | | | | Counter and De-sync detect |
| | | | | Timer set to 0, the HFN de- |
| | | | | synchronization detection at |
| | | | | Node B should be stopped. |

Another example is an HFN de-synchronization detection Configuration IE that provides information for a Node B to perform HFN de-synchronization detection such as set forth in the Table 4 below.

TABLE 4

| | | | IE Type | |
|---|---|---|---|---|
| IE/Group | Pre- | | and | Semantic |
| name | sence | Range | Reference | Description |
| logical channel | 1..15 | | | |
| ID | | | | |
| >De-sync | M | | INTEGER | |
| detect Counter | | | (0..8191) | |
| >De-sync | M | | INTEGER | |
| detect Timer | | | (0..8191) | |

The new information may also be applied to the Iub (TS 25.435)/Iur (TS 25.425) user plane frame protocol, by adding into the existing HS-DSCH data frame, the existing HS-DSCH control frame, or by creating a new HS-DSCH control frame.

Alternatively, the RNC may send an NBAP control plane or UP FP message containing a list with the following (or a subset of the following) information elements: MAC-d ID, logical channel ID, queue ID, De-sync Detect Counter, and/or De-sync Detect Timer.

Example Apparatus for Error Indication/Notification.

Once the error is detected, it is reported to one or more higher layers so that some type of corrective or preventive action may be taken. Example alternatives and embodiments are now described for configuring and reporting the error detection. Depending on how the error detection is configured, the error notification/indication may use the same or similar IEs as in the error detection configuration message sent by the RNC. Ultimately, the Node B may send the error indication/notification in various ways. It may also be specified that when the RNC does not configure the de-sync detection counter and/or timer, the Node B should not perform any de-sync detection. It may also be specified that when the RNC configures the de-sync detection counter and/or timer to certain values, the Node B should stop the de-sync detection. It may also be specified the Node B should perform de-sync detection with the configuration in Node B, not via RNC.

The Node B preferably provides an error indication/notification per Priority Queue, HS-DSCH MAC-d flow, and/or logical channel. As non-limiting examples, the error indication may be defined as an HARQ failure, a MAC-d failure, or HFN de-synchronization Indication, etc. The technology may be applied to the NBAP (TS 25.433)/RNSAP (25.423) control plane by adding into the existing message or by creating new dedicated message. One non-limiting example is given in the Table 5 below.

TABLE 5

| IE/Group | Pre- | | IE Type and | Semantics |
|---|---|---|---|---|
| Name | sence | Range | Reference | Description |
| HFN de-sync | 1..8 | | | A loop to max 8 |
| Indication | | | | |
| >Priority Queue | O | | INTEGER | Indicates the Priority |
| ID | | | (0..7) | Queue ID |
| >HS-DSCH | M | | INTEGER | Indicates the HS-DSCH |
| MAC-d ID | | | (0..7) | MAC-D associated with |
| | | | | the Priority Queue |
| >logical channel | O | | INTEGER | Indicates the logical |
| ID | | | (1..15) | channel |
| >HFN de-syn- | M | | ENUMERATED | Indicates the HFN de- |
| chronization | | | (failure,...) | synchronization failure |
| Indication | | | | detected. |

Another non-limiting example is given in the Table 6 below.

TABLE 6

| IE/Group | Pre- | | IE Type and | Semantics |
|---|---|---|---|---|
| Name | sence | Range | Reference | Description |
| HFN de-sync | 1..8 | | | A loop to max 8 |
| Indication | | | | |
| >HS-DSCH | M | | INTEGER (0..7) | Indicates the |
| MAC-d ID | | | | HS-DSCH |
| | | | | MAC-D |
| | | | | associated with |
| | | | | the Priority |
| | | | | Queue |
| >logical | 1..15 | | | Indicates the |
| channel ID | | | | logical channel |
| >>HFN de- | M | | ENUMERATED | Indicates the |
| synchronization | | | (failure,...) | HFN de- |
| Indication | | | | synchronization |
| | | | | failure detected. |

The new IEs for HFN de-sync indication/notification may, as a non-limiting example, be added on NBAP/RNSAP to an existing IE “HS-DSCH FDD Update Information.” This IE is included in the dedicated Radio Link message “RADIO LINK PARAMETER UPDATE INDICATION.” It can be added directly to the NBAP/RNSAP “RADIO LINK PARAMETER UPDATE INDICATION.” It can also be applied to Iub (TS 25.435)/Iur (TS 25.425) user plane frame protocol by adding into the existing HS-DSCH data frame, the existing HS-DSCH control frame, or by creating a new HS-DSCH control frame.

### Example 1

For the downlink (DL), the RNC configures one or more counters and/or timers per different instances of MAC-d flows/reorderings/queues/logical channel identities (one or more) that are signaled to the NodeB. When the error event is detected by the MAC controller in the transmitting NodeB, an indication of the error event may be sent from the NodeB to the RNC for each instance independently.

### Example 2

For the DL, one or more counters and/or timers are statically configured in the NodeB. When an error event is detected by the MAC controller in the transmitting NodeB, an indication of the error event may be sent from the NodeB to the RNC.

### Example 3

For the uplink (UL), the RNC configures one or more timers or counters that are signaled to the NodeB. When an error event is detected by the MAC controller in the transmitting NodeB, an indication of the error event may be sent from the NodeB to the RNC.

### Example 4

For the UL, one or more counters and/or timers are statically configured in the NodeB. When an error event is detected by the MAC controller in the transmitting NodeB, an indication of the error event may be sent from the NodeB to the RNC.

### Example 5

The indication of an error event is achieved by adding a new IE Indicator in the existing Control Plane message in Node B Application Part (NBAP) 3GPP TS25.433v11.0.0 and Radio Network Subsystem Application Part (RNSAP) 3GPP TS25.423v11.1.0, both of which are incorporated by reference, or adding a new indication message, so that the Node B can inform the RNC of the error detected at the MAC layer. For example, a new Information Element (IE) may be added to the in NBAP/RNSAP “RADIO LINK PARAMETER UPDATE INDICATION” message. A new IE, for example “MAC Failure Indication,” may be defined to indicate DL/UL MAC error detection or “failure indication.” More detailed failure information can also be defined.

The example Table 7 below is adapted from 3GPP NBAP TS 25.433 chapter 9.2.2.18Ea “HS-DSCH FDD Update Information,” which provides information for HS-DSCH to be updated using at least one IE.

TABLE 7
RADIO LINK PARAMETER UPDATE INDICATION

| IE/Group | | | IE Type and | Semantics | | Assigned |
|---|---|---|---|---|---|---|
| Name | Presence | Range | Reference | Description | Criticality | Criticality |
| HS-SCCH | O | | 9.2.1.31K | | — | |
| Code | | | | | | |
| Change | | | | | | |
| Indicator | | | | | | |
| CQI | O | | 9.2.2.21B | | — | |
| Feedback | | | | | | |
| Cycle k | | | | | | |
| CQI | O | | 9.2.2.4Cb | | — | |
| Repetition | | | | | | |
| Factor | | | | | | |
| ACK-NACK | O | | 9.2.2.a | | — | |
| Repetition | | | | | | |
| Factor | | | | | | |
| CQI Power | O | | 9.2.2.4Ca | | — | |
| Offset | | | | | | |
| ACK Power | O | | 9.2.2.b | | — | |
| Offset | | | | | | |
| NACK | O | | 9.2.2.23a | | — | |
| Power | | | | | | |
| Offset | | | | | | |
| HS-PDSCH | O | | 9.2.1.31M | | YES | ignore |
| Code | | | | | | |
| Change | | | | | | |
| Indicator | | | | | | |
| HFN de- | 0 . . . 8 | | | An optional | | |
| synchronization | | | | loop to | | |
| Indication | | | | max 8 | | |
| >HS- | M | | INTEGER (0 . . . 7) | It indicates | YES | ignore |
| DSCH | | | | the HS- | | |
| MAC-d ID | | | | DSCH | | |
| | | | | MAC-D | | |
| | | | | associated | | |
| | | | | with the | | |
| | | | | Priority | | |
| | | | | Queue | | |
| >HFN de- | M | | ENUMERATED | It indicates | YES | ignore |
| sync | | | (failure, . . . ) | the HFN | | |
| Indication | | | | de- | | |
| | | | | synchronization | | |
| | | | | failure | | |
| | | | | detected. | | |

### Example 6

The Indication of Error Detection from the NodeB to the RNC May be achieved by using the reserved/spare bits in 3GPP TS25.435v10.4.0 (Iub UP Prot) and 3GPP TS25.425v10.2.0 (Iur UP Prot), incorporated herein by reference, to send the indication from Node B to RNC in the control frame or data frames.

In 3GPP TS25.425v10.2.0, chapter 6.3.3.11 HS-DSCH CAPACITY ALLOCATION for example, the “6” and “7” in first octet in the CA frame may be used and these new interpretations may be assigned if either is set to “1”. This mapping may be implemented for both Capacity Allocation (CA) type 1 and/or type 2. Spare extensions in this frame can also be used as another alternative. If bit “7” is set to “0,” then the legacy interpretation is applied to the interpretation of the CA frame contents. But if this bit is set to “1,” then the CA frame is understood to indicate that HARQ failure has occurred on the DL. If bit “6” is set to “0,” then a legacy interpretation is applied to the interpretation of the CA frame contents. But if this bit is set to “1,” then the CA frame is understood to indicate that HARQ failure has occurred on the UL. This indication may then be sent either once per occurrence of HARQ failure within a specified time or each time a HARQ failure occurs, i.e., one CA frame with the above-mentioned alternative mapping is sent once for every TTI that HARQ failure occurs in the UL or DL.

### Example 7

Bits “6” and “7” in a first octet in a CA frame are used to indicate that the CA frame contains HARQ failure information for either the UL or the DL and that the “HS-DSCH Credits” field of the CA frame contains additional HARQ failure information. The “HS-DSCH Credits” field could thus contain such information as the number of TTI's for which HARQ failure has occurred and a measure of how many bits each failed TTI attempted to transmit. See the two Tables below. Both embodiment features provide the RNC with sufficient information to determine if the sequence number (SN) of the transmitting and receiving RLC entities are unaligned or out of sync, and consequently, whether the HFN should be offset.

CA type 1 in 3 GPP TS25.435v10.4.0, chapter 6.3.3.11:

TABLE 8
CA type 1

| | | |
|---|---|---|
| Spare | Congestion | |
| bits 7-6 | Status | CmCH-PI |

Maximum MAC-d PDU Length

| | |
|---|---|
| Maximum MAC-d PDU | HS-DSCH Credits |
| Length (cont) | |

HS-DSCH Credits (cont)
HS-DSCH Interval
HS-DSCH Repetition Period
Spare Extension

CA type 2:

TABLE 9
CA type 2

| | | |
|---|---|---|
| Spare | Congestion | CmCH-PI |
| bits 7-6 | Status | |

| | |
|---|---|
| Spare bits 7-3 | Max. MAC-d/c |
| | PDU Length |

Maximum MAC-d/c PDU Length (cont)
HS-DSCH Credits
HS-DSCH Credits (cont)
HS-DSCH Interval
HS-DSCH Repetition Period
Spare Extension

### Example 8

The counters and/or timers are signaled by the RNC to the NodeB. The new counter(s) and timer(s) can be included in the NBAP/RNSAP Control Plane signaling when RNC sets up the dedicated Radio Link, and/or when RNC reconfigures the existing Radio Link, for example in RADIO LINK SETUP REQUEST/RADIO LINK ADDITION REQUEST/RADIO LINK RECONFIGURATION PREARE/RADIO LINK RECONFIGURATION REQUEST messages described in TS25.433 and TS25.423. The new counter(s) and timer(s) can also be signaled from RNC to Node B/DRNC in the Iur/Iub user plane Frame protocols.

### Example 9

For the UL, the RNC configures one or more counters and/or timers that are signaled to the UE. When the failure is detected by the MAC controller in the UE, an indication may be sent from the UE to the RNC.

### Example 10

For the UL, one or more counters and/or timers are statically configured in the UE. When the failure is detected by the MAC controller in the UE, an indication may be sent from the UE to the RNC.

### Example 11

The counters and/or timers configured by the RNC and signaled to the UE, may be signaled in any of the following RRC messages (see TS25.331v11.1.0 “Radio Resource Control (RRC); Protocol specification”): RRC CONNECTION SETUP, RADIO BEARER SETUP, RADIO BEARER RECONFIGURATION, MEASUREMENT CONTROL.

### Example 12

The UL HARQ failure may be signaled by the UE to the RNC by means of any of the following RRC messages (see 3GPP TS25.331v11.1.0): CELL UPDATE, SIGNALLING CONNECTION RELEASE INDICATION, MEASUREMENT REPORT.

Error Correction.

RLC UM may be configured for applications such as Voice over IP (VoIP). VoIP applications transmit data periodically, for example, every 20 ms but other rates may be possible. For example and illustrative purposes, this periodicity is called T_Period. As explained above, the Hyper Frame Number (HFN) is increased by the transmitter after the last sequence number has been transmitted. The HFN is increased by the receiver after the last sequence number has been received. For example, if 7 bits are used to indicate the sequence number, after 128 received RLC PDUs, the receiver increases the HFN by one. In the time domain, after 128×T_Period, the receiver increases the HFN value by one. In this context, 128×T_Period is called HFN_Update_Period. The same applies for the transmitter.

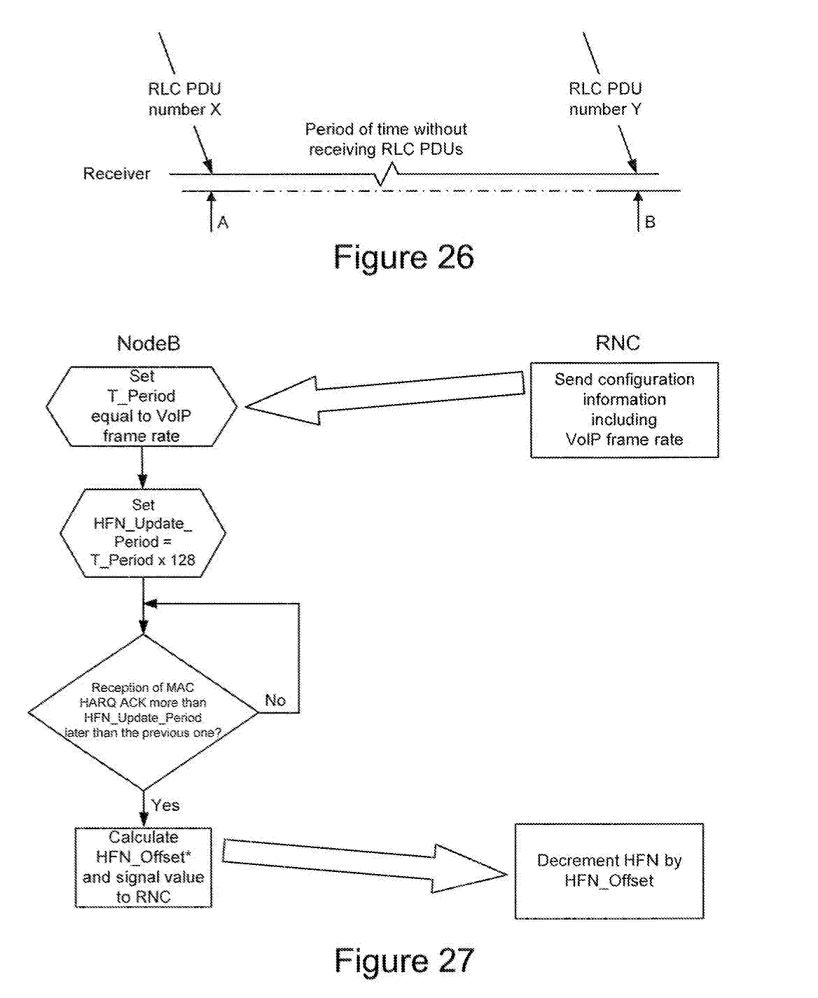

After HFN de-sync detection, the detecting node (NodeB) calculates the elapsed time between A and B (see FIG. 26). Time A is the time when the last RLC PDU was received by the UE, i.e. the corresponding MAC PDU was positively acknowledged. Time B is the time when a new RLC PDU is received (i.e. the corresponding MAC PDU is positively acknowledged).

The elapsed time is divided by the HFN_Update_Period. The quotient of the division (HFN_Offset) should be rounded to the lowest integer. The HFN_Offset is signaled from the NodeB to the RNC. The HFN at time B should be the HFN at time A plus the HFN_offset. Since the UE hasn't been able to increment its HFN by HFN_Offset, the RNC will decrement its HFN by HFN_Offset in order to match the HFN at the UE side.

Consider the following non-limiting example:

T_Period is equal to 20 ms.
HFN at time A is equal to 34.
Elapsed time between B and A is 7620 milliseconds.

### HFN_Offset=(7680)/(128×20)=3.

HFN at time B=HFN at time A+3=37.
The RNC resets the HFN to the HFN at time A i.e. HFN at time B−3=37−3=34.
The RNC conveys T_Period to the NodeB via the Iub. The NodeB conveys the HFN_Offset to the RNC via the Iub.
FIG. 27 is a flowchart showing example procedures for synchronizing the UE and RNC in a Voice over IP (VoIP) example context. The RNC sends configuration information including VoIP frame rate to the NodeB. The NodeB sets a time period equal to that VoIP frame rate and sets an HFN update period. A determination is made whether the elapsed time between two consecutively received MAC PDUs exceeds the HFN update period. If so, then the HFN in the RNC modified using an HFN_Offset value in accordance with the following equation:

HFN_Offset=round_down[(T(B)−T(A))/HFN_Update_Period].

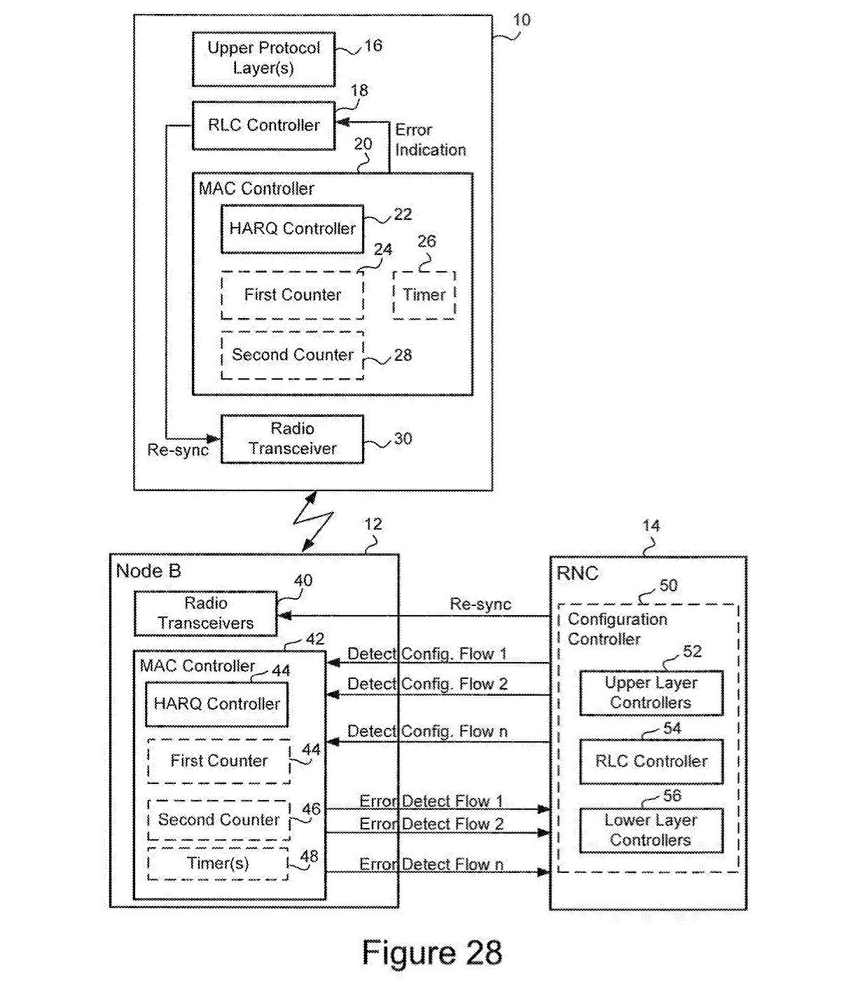

FIG. 28 shows non-limiting example function block diagrams of a UE 10, NodeB 12, and RNC 14 that may be used to implement the technology described above. Some or all of the function blocks in each of the UE, NodeB, and RNC may be implemented or realized by machine. The machine may take any of several forms, such as (for example) electronic circuitry in the form of a computer implementation or hardware circuitry. A computer implementation may be realized by or implemented as one or more computer processors or controllers which may execute instructions stored on non-transitory, computer-readable storage media. In such a computer implementation, a machine may comprise, in addition to a processor(s), a memory section (which in turn can comprise random access memory, read only memory, an application memory (a non-transitory computer readable medium which stores, e.g., coded non instructions which can be executed by the processor to perform acts described herein), and any other memory such as cache memory, for example). Another example platform suitable is that of hardware circuitry, e.g., an application specific integrated circuit (ASIC), a digital signal processor (DSP), a programmable gate array (PGA), etc., where circuit elements are structured and operated to perform the various acts described herein.

The UE includes a radio transceiver 30 and one or more antennas and a MAC controller 20 including an HARQ controller 22. Depending on the example embodiment, the MAC controller 20 may also include one or more counters 24, 28 and/or a timer 26 to perform the functions described above. As indicated with an arrow, an error indication message is provided by the MAC controller 20 to an RLC controller 18, which may then take appropriate action to correct that error, such as re-synchronizing the UE radio transceiver timing with that of the NodeB. The RLC controller also communicates with one or more upper protocol layers 16.

The NodeB 12 includes multiple radio transceivers 40 and one or more antennas and a MAC controller 42 including an HARQ controller 44. Depending on the example embodiment, the MAC controller 42 may also include one or more counters 44, 46 and/or timers 48 to perform the functions described above. The MAC controller 42 receives an error detection configuration message from the RNC 14 for each of one or more individual data flows, logical channels, priority queues, etc. The RNC 14 includes a configuration controller 50 which selectively generates individual error detection configuration messages shown in the example in FIG. 28 for data flows 1, 2, . . . , n. Based on the error detection configuration messages the MAC controller 42 in the Node B 12 monitors each of the configured data flows using corresponding counter and/or timer instances assigned to each of those flows. If an error is detected for one of those flows based on an output from the corresponding counter and/or timer instances, the Node B MAC controller 42 sends an error detection indication message to the RLC controller 54 in the RNC 14 for the respective data flow. The RNC 14 may then take appropriate action to correct that error for that data flow, such as re-synchronizing the UE radio transceiver timing with that of the NodeB for that data flow. The RLC controller 54 also communicates with one or more upper protocol layers 52.

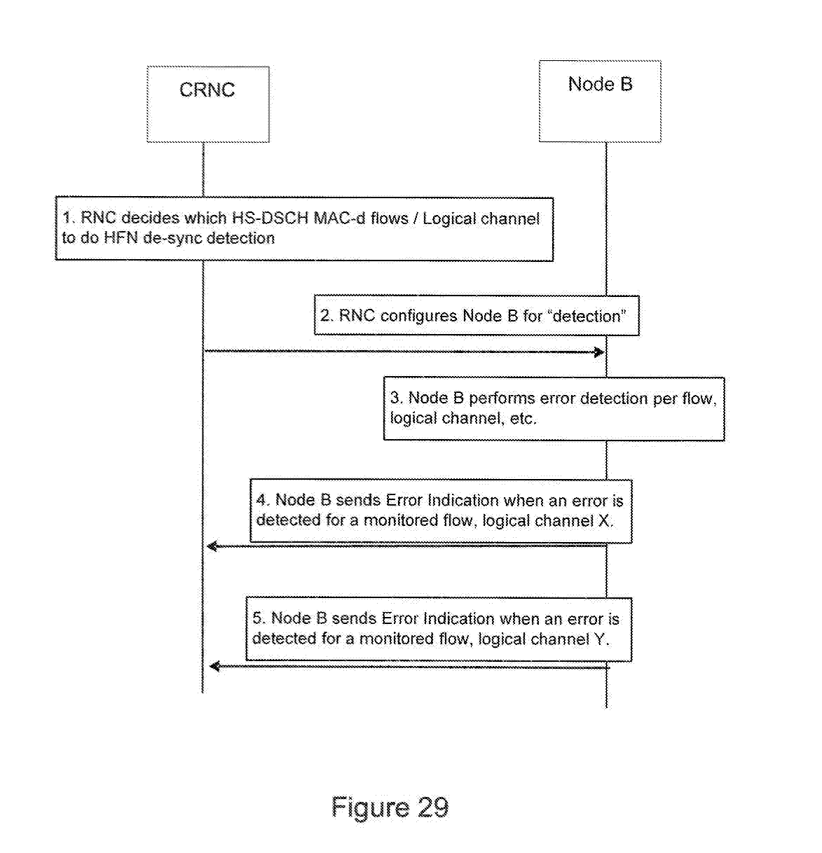

FIG. 29 shows a signaling diagram illustrating non-limiting example messaging between a controlling RNC (CRNC) and the Node B over NBAP. If the Node B is connected to a drift RNC (DRNC), the signaling is sent first over Radio Network Subsystem Application Part (RNSAP) between the serving RNC (SRNC) and the DRNC. The CRNC initially determines for which HS-DSCH MAC-d flows/logical channels for a UE connection/radio bearer error detection, e.g., HFN de-sync detection, and reporting will be performed. The Node B receives the configuration information from the RNC and establishes configuration settings in accordance therewith. Next, the Node B performs error detection per flow, logical channel, etc. as configured. The Node B sends an Error Indication when an error is detected for a monitored flow, logical channel. Two example instances are shown for monitored flow, logical channel X and monitored flow, logical channel Y.

The technology described here includes many advantages. For example, the technology allows detection of a loss of MAC PDUs which leads to a loss of synchronization between transmitter and receiver. In the non-limiting UTRAN example, the loss of synchronization may correspond to HFN misalignment, and as a result, a subsequent ciphering error in the case of RLC UM communications between a UE and the network. One or more configurable counters and/or a timer may be used to detect a loss of MAC PDUs which may lead to such HFN misalignment. The technology is flexible in that static or dynamic (network configurable) setting of error detection configuration(s) may be used. The error or failure reporting mechanism allows the UE and/or the network node to take corrective action, e.g., to recover the HFN alignment or reconfigure or release the RLC UM entity. As mentioned above, recovery from HFN de-synchronization may avoid or allows recovery from the ciphering error. The technology, as mentioned above, finds wide application. But one example application is Voice over IP (VoIP) services, which makes use of RLC UM. Other example advantages include the RNC configuring a Node B to detect the de-sync per HS-DSCH MAC-d flow, priority Queue, or logical channel. As a result, the RNC specify that de-sync error detection and/or notification only be performed by a Node B for specific HS-DSCH MAC-d flow(s), priority Queue(s), or logical channel(s) and not for others.

Although the description above contains many specifics, they should not be construed as limiting but as merely providing illustrations of some presently preferred embodiments. Embodiments described herein may be considered as independent embodiments or may be considered in any combination with each other to describe non-limiting examples. Although non-limiting, example embodiments of the technology were described in a UTRAN context, the principles of the technology described may also be applied to other radio access technologies. For example, in an LTE system, the NodeB and RNC in UTRAN correspond to a single node, the eNodeB, in LTE. Ciphering in LTE is similar to that in UTRAN, but it is performed at a Packet Data Convergence Protocol, PDCP, layer, and the sequence number range is not necessarily 7 bits but can be configured by upper layers (values: 5, 7, 12, 15). The input count is 32 bits and contains HFN and SN as in UTRAN. When the RLC is informed by MAC that a predetermined number of (consecutive) transmission errors has been detected, actions by RLC may include informing PDCP about the transmission errors. While the error detection and error correction mechanisms would be similar, the configuration and signaling would be different. For example, there is no need to signal between the RNC and the NodeB, and the RRC signaling between the RNC and UE would be handled by RRC signaling between the UE and eNodeB.

Indeed, the technology fully encompasses other embodiments which may become apparent to those skilled in the art. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for a device or method to address each and every problem sought to be solved by the described technology for it to be encompassed hereby.

1. A method in a transmitting node communicating with a receiving node using a multi-layer communications protocol having a lower media access control, MAC, layer and a higher radio link control, RLC, layer, where an RLC controller operates in an RLC unacknowledged mode, RLC UM, and where a MAC controller operates using hybrid automatic repeat request, HARQ, for transmitted MAC protocol data units, the method comprising:
the RLC controller in the RLC UM transmitting RLC protocol data units via the MAC layer, and
the MAC controller monitoring transmission errors at the MAC layer and informing the RLC controller when detecting a predetermined number of consecutive transmission errors or a predetermined number of transmission errors during a predetermined time period so that the RLC controller can perform one or more actions.

2. The method in claim 1, wherein in the RLC UM, the RLC controller does not receive any feedback information regarding correct or erroneous reception of the transmitted RLC protocol data units by the receiving node.

3. The method in claim 1, wherein the transmission errors are MAC protocol data unit, MAC PDU, transmission failures which occur when a maximum number of HARQ transmissions for a MAC PDU is reached without receiving a positive acknowledgement for that MAC PDU.

4-12. (canceled)

13. A method in a radio network control node, RNC, communicating with a user equipment, UE, via a radio base station over a radio interface using a multi-layer communications protocol having a lower media access control, MAC, layer and a higher radio link control, RLC, layer, where an RLC controller in the RNC operates in an RLC unacknowledged mode, RLC UM, and where a MAC controller in the base station operates using hybrid automatic repeat request, HARQ, for transmitted MAC data units, the method implemented in the RNC comprising:
determining one or more parameters associated with the communication between the UE and the radio network control node for the base station to monitor;
configuring the radio base station to detect when a predetermined number of consecutive transmission errors or a predetermined number of transmission errors during a predetermined time period occurs;
receiving from the radio base station a message indicating the occurrence of a predetermined number of consecutive transmission errors or a predetermined number of transmission errors during a predetermined time period; and
sending a correction message to the radio base station based on the received message.

14. The method in claim 13, wherein the correction message includes information to permit synchronization between the UE and the radio base station.

15. The method in claim 14, wherein the information includes a time offset to a transmission frame number.

16. The method in claim 13, wherein in the RLC UM, the RLC controller does not receive any feedback information regarding correct or erroneous reception of the transmitted RLC protocol data units by the receiving node.

17-19. (canceled)

20. Transmission apparatus configured to communicate with a receiving node using a multi-layer communications protocol having a lower media access control, MAC, layer and a higher radio link control, RLC, layer, the transmission apparatus comprising:
an RLC controller configured to operate in an RLC unacknowledged mode, RLC UM, to transmit RLC protocol data units via the MAC layer, and
a MAC controller configured to:
operate using hybrid automatic repeat request, HARQ,
monitor transmission errors at the MAC layer, and
inform the RLC controller when detecting a predetermined number of consecutive transmission errors or a predetermined number of transmission errors during a predetermined time period so that the RLC controller can perform one or more actions.

21. The transmission apparatus in claim 20, wherein in the RLC UM, the RLC controller is configured to not receive any feedback information regarding correct or erroneous reception of the transmitted RLC protocol data units by the receiving node.

22. The transmission apparatus in claim 20, wherein the transmission errors are MAC protocol data unit, MAC PDU, transmission failures which occur when a maximum number of HARQ transmissions for a MAC PDU is reached without receiving a positive acknowledgement for that MAC PDU.

23. The transmission apparatus in claim 22, wherein the MAC controller is configured to use a counter to account for each MAC PDU transmission failure, and wherein the counter is configured to be reset if the transmission of a MAC PDU is successful.

24. The transmission apparatus in claim 22, wherein the MAC controller uses a counter to account for each MAC PDU transmission failure occurring during the predetermined time period.

25. The transmission apparatus in claim 20, wherein the RLC controller is configured to perform ciphering of data units to be transmitted.

26. The transmission apparatus in claim 20, wherein the RLC controller and the MAC controller are configured to operate for each of multiple data flows, each of multiple logical channels, or each of multiple priority queues.

27. The transmission apparatus in claim 20, wherein the transmitting apparatus is included in a user equipment, UE, and the receiving node is a radio base station.

28. The transmission apparatus in claim 20, wherein a radio network controller, RNC, includes the RLC controller, and a radio base station communicating with the RNC and a user equipment, UE, includes the MAC controller, and wherein the MAC controller in the radio base station is configured to send an error message to the RLC controller in the RNC so that the RNC controller can perform the one or more actions.

29. The transmission apparatus in claim 28, wherein the RNC is configured to transmit to the radio base station a message indicating one or more data flows and/or one or more logical radio channels to be monitored for errors, and the radio base station is configured, in response, to configure one or more de-synchronization detecting counter(s) and/or timer(s) for each of the one or more specific data flows, one or more specific logical channels, or one or more multiple priority queues indicated in the message,
wherein when the configured one or more de-synchronization detecting counter(s) and/or timer(s) detect an error, the radio base station is configured to send a de-synchronization message to the RNC indicating de-synchronization between the UE and the radio base station.

30. The transmission apparatus in claim 20, wherein the RLC controller and the MAC controller are configured to support voice over IP, VoIP, communications, wherein the one or more actions includes an indication that a lack of synchronization is affecting the transmitting and receiving nodes the RLC controller i.

31. The transmission apparatus in claim 30, wherein the transmission apparatus is configured to:
determine an elapsed time between two consecutively-received RLC protocol data units;
determine a timing offset using the elapsed time; and
use the timing offset to acquire synchronization.

32. A radio network controller, RNC, configured to communicate with a user equipment, UE, via a radio base station over a radio interface using a multi-layer communications protocol having a lower media access control, MAC, layer and a higher radio link control, RLC, layer, where an RLC controller in the RNC operates in an RLC unacknowledged mode, RLC UM, and where a MAC controller in the base station operates using hybrid automatic repeat request, HARQ, for transmitted MAC data units, the RNC comprising:
one or more processors configured to:
determine one or more parameters associated with the communication between the UE and the radio network control node for the base station to monitor;
configure the radio base station to detect when a predetermined number of consecutive transmission errors or a predetermined number of transmission errors during a predetermined time period occurs;
the RNC being configured to receive from the radio base station a message indicating the occurrence of a predetermined number of consecutive transmission errors or a predetermined number of transmission errors during a predetermined time period; and
the RNC being configured to send a correction message to the radio base station based on the received message.

33. The RNC in claim 32, wherein the correction message includes information to permit synchronization between the UE and the radio base station.

34. The RNC in claim 33, wherein the information includes a time offset to a transmission frame number.

35. The RNC in claim 32, wherein in the RLC UM, the RLC controller is configured to not receive any feedback information regarding correct or erroneous reception of the transmitted RLC protocol data units by the receiving node.

36-39. (canceled)

40. The transmission apparatus in claim 31, wherein the RLC controller transmission apparatus is configured to divide the elapsed time by a voice over IP, VoIP, transmission rate so that the timing offset is determined using based on the elapsed time divided by the VoIP transmission rate.
